(19) United States
(12) Patent Application Publication
(10) Pub. No.: US 2024/0362555 A1
(43) Pub. Date: Oct. 31, 2024

(54) SYSTEM AND METHOD FOR MANAGING SUBSCRIPTIONS ASSOCIATED WITH CLOUD SERVICES

(71) Applicant: ORACLE INTERNATIONAL CORPORATION, Redwood Shores, CA (US)

(72) Inventors: Deepalkumar Shah, New York, NY (US); Matthew Rushton, Portsmouth, NH (US); Stephen Drye, Arlington, MA (US); Rohit Shetty, Cary, NH (US)

(21) Appl. No.: 18/639,793

(22) Filed: Apr. 18, 2024

Related U.S. Application Data
(60) Provisional application No. 63/462,878, filed on Apr. 28, 2023.

(51) Int. Cl. G06Q 10/0631

(52) U.S. Cl. CPC G06Q 10/06312

(57) ABSTRACT

Embodiments described herein are generally related to systems and methods for providing cloud environments, for use by tenants of a cloud infrastructure environment in accessing software products, services, or other offerings associated with the environment, including the use of a cloud subscription manager service or component for managing subscriptions associated with cloud services. A subscription manager can be provided within a cloud infrastructure environment, and can be utilized to create and manage subscriptions, such as the subscriptions of customers of the operators. Upon the determination of a lifecycle event associated with the subscription for a service, a stream event can be created and published to an event stream by the subscription manager. This stream event can be recorded by the subscription manager as an entry in a data store comprising the event stream managed by the subscription manager, and thereafter used in managing the subscription.

### CLAIM OF PRIORITY AND CROSS-REFERENCE TO RELATED APPLICATIONS

This application claims the benefit of priority to U.S. Provisional patent application titled “SYSTEM AND METHOD FOR PROVIDING DEDICATED CLOUD ENVIRONMENTS FOR USE WITH A CLOUD COMPUTING INFRASTRUCTURE”, Application No. 63/462,878, filed Apr. 28, 2023; and is related to U.S. Provisional patent application titled “SYSTEM AND METHOD FOR PROVIDING DEDICATED CLOUD ENVIRONMENTS FOR USE WITH A CLOUD COMPUTING INFRASTRUCTURE”, Application No. 63/462,868, filed Apr. 28, 2023; U.S. Provisional patent application titled “SYSTEM AND METHOD FOR PROVIDING DEDICATED CLOUD ENVIRONMENTS FOR USE WITH A CLOUD COMPUTING INFRASTRUCTURE”, Application No. 63/462,875, filed Apr. 28, 2023; U.S. Provisional patent application titled “SYSTEM AND METHOD FOR PROVIDING DEDICATED CLOUD ENVIRONMENTS FOR USE WITH A CLOUD COMPUTING INFRASTRUCTURE”, Application No. 63/462,880, filed Apr. 28, 2023; U.S. Provisional patent application titled “SYSTEM AND METHOD FOR PROVIDING DEDICATED CLOUD ENVIRONMENTS FOR USE WITH A CLOUD COMPUTING INFRASTRUCTURE”, Application No. 63/462,882, filed Apr. 28, 2023; and U.S. Provisional patent application titled “SYSTEM AND METHOD FOR PROVIDING DEDICATED CLOUD ENVIRONMENTS FOR USE WITH A CLOUD COMPUTING INFRASTRUCTURE”, Application No. 63/462,885, filed Apr. 28, 2023; each of which above applications and the contents thereof are herein incorporated by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

Embodiments described herein are generally related to systems and methods for providing cloud environments, for use by tenants of a cloud infrastructure environment in accessing software products, services, or other offerings associated with the environment, including the use of a cloud subscription manager service or component for managing subscriptions associated with cloud services.

### BACKGROUND

A cloud computing environment can be used to provide access to a range of complementary cloud-based components, such as software applications or services, that enable organizations or enterprise customers to operate their applications and services in a highly-available hosted environment.

The benefits to an organization in moving their application and service needs to a cloud environment include a reduction in the cost and complexity of designing, building, operating, and maintaining their own on-premise data center, software application framework, or other information technology infrastructure; allowing them to instead focus on managing their day-to-day business.

### SUMMARY

Embodiments described herein are generally related to systems and methods for providing cloud environments, for use by tenants of a cloud infrastructure environment in accessing software products, services, or other offerings associated with the environment, including the use of a cloud subscription manager service or component for managing subscriptions associated with cloud services.

In accordance with an embodiment, a cloud computing environment can comprise realms which can be, for example, associated with operators, and which can be utilized to allow operators to provide to their customers services and other offerings of the cloud environment.

In accordance with an embodiment, a subscription manager can be provided within a cloud infrastructure environment, and can be utilized to create and manage subscriptions, such as the subscriptions of customers of the operators. A subscription can be used internally to create and manage subscriptions of operators, as well as users of the cloud infrastructure environment. The subscription manager can allow operators to, for example, have customers rapidly onboarded, as well as manage their own customers, and subscriptions independently of the cloud infrastructure environment provider.

In accordance with an embodiment, upon the determination of a lifecycle event associated with the subscription for a service, a stream event can be created and published to an event stream by the subscription manager. This stream event can be recorded by the subscription manager as an entry in a data store comprising the event stream managed by the subscription manager, and thereafter used in managing the subscription.

### BRIEF DESCRIPTION OF THE DRAWINGS

FIG. 1 illustrates a system for providing a cloud infrastructure environment, in accordance with an embodiment.

FIG. 2 further illustrates how a cloud infrastructure environment can be used to provide cloud-based applications or services or services, in accordance with an embodiment.

FIG. 3 illustrates an example cloud infrastructure architecture, in accordance with an embodiment.

FIG. 4 illustrates another example of a cloud infrastructure architecture, in accordance with an embodiment.

FIG. 5 illustrates another example of a cloud infrastructure architecture, in accordance with an embodiment.

FIG. 6 illustrates another example of a cloud infrastructure architecture, in accordance with an embodiment.

FIG. 7 illustrates a system that provides dedicated or private label cloud environments, for use by tenants or customers of a cloud infrastructure environment, in accordance with an embodiment.

FIG. 8 further illustrates the use of cloud realms, for use by tenants or customers of a cloud infrastructure environment, in accordance with an embodiment.

FIG. 9 further illustrates the use of cloud realms, for use by tenants or customers of a cloud infrastructure environment, in accordance with an embodiment.

FIG. 10 illustrates a system for providing access to software products or

services in a cloud computing or other computing environment, in accordance with an embodiment.

FIG. 11 illustrates a system for managing subscriptions associated with cloud services, in accordance with an embodiment.

FIG. 12 illustrates exemplary lifecycles for services, in accordance with an embodiment.

FIG. 13 illustrates a flow chart for an order creation, in accordance with an embodiment.

FIG. 14 is a flowchart of an order creation, in accordance with an embodiment.

FIG. 15 is a flowchart of an order creation, in accordance with an embodiment.

FIG. 16 is a flowchart of an order creation, in accordance with an embodiment.

FIG. 17 illustrates a flowchart for an authorization model, in accordance with an embodiment.

FIG. 18 illustrates various tenancies, in accordance with an embodiment.

FIG. 19 is a flowchart of a method, in accordance with an embodiment.

### DETAILED DESCRIPTION

A cloud computing or cloud infrastructure environment can be used to provide access to a range of complementary cloud-based components, such as software applications or services, which enable organizations or enterprise customers to operate their applications and services in a highly-available hosted environment.

The benefits to an organization in moving their application and service needs to a cloud infrastructure environment include a reduction in the cost and complexity of designing, building, operating, and maintaining their own on-premise data center, software application framework, or other information technology infrastructure; allowing them to instead focus on managing their day-to-day business.

### Cloud Infrastructure Environments

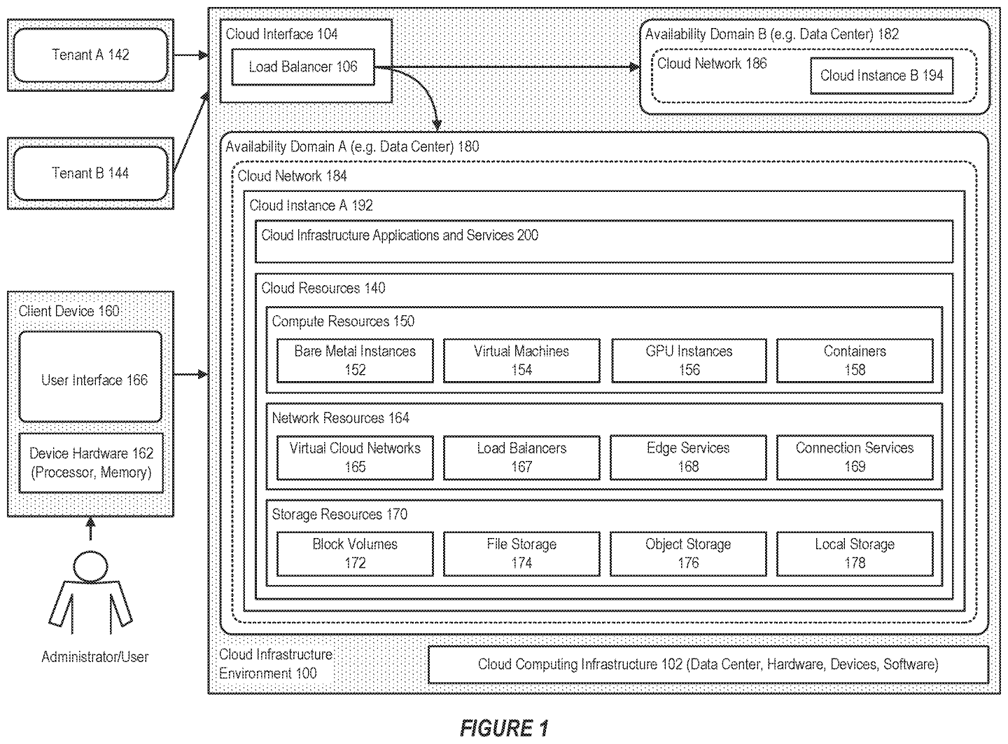

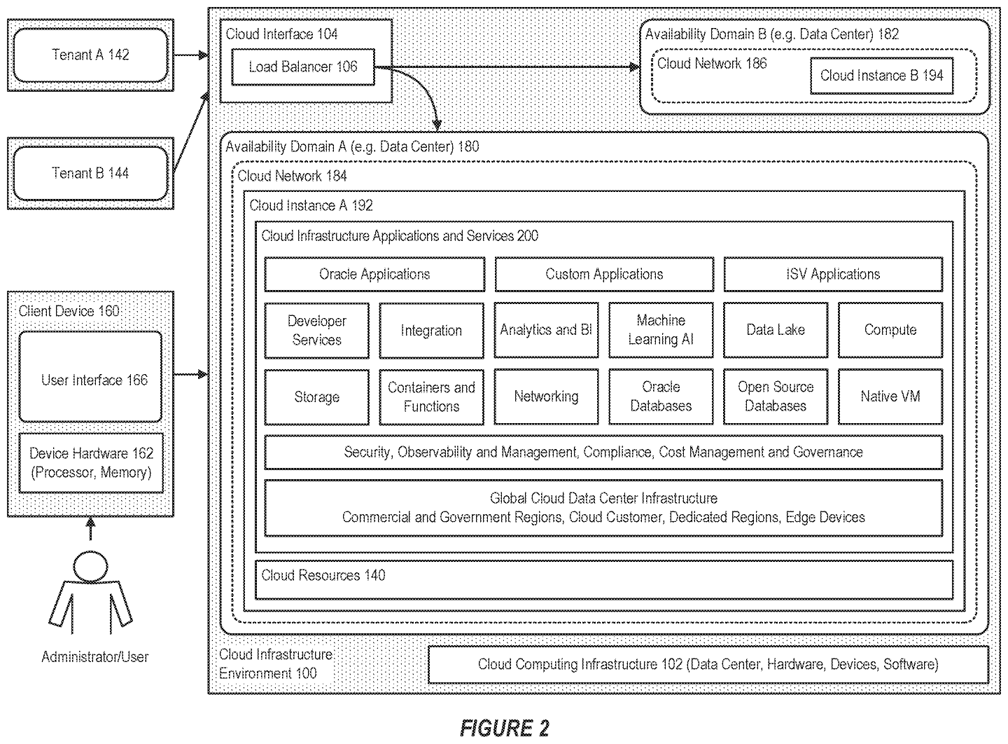

FIGS. 1 and 2 illustrate a system for providing a cloud infrastructure environment, in accordance with an embodiment.

In accordance with an embodiment, the components and processes illustrated in FIG. 1, and as further described herein with regard to various embodiments, can be provided as software or program code executable by a computer system or other type of processing device, for example a cloud computing system.

The illustrated example is provided for purposes of illustrating a computing environment which can be used to provide dedicated or private label cloud environments, for use by tenants of a cloud infrastructure in accessing subscription-based software products, services, or other offerings associated with the cloud infrastructure environment. In accordance with other embodiments, the various components, processes, and features described herein can be used with other types of cloud computing environments.

As illustrated in FIG. 1, in accordance with an embodiment, a cloud infrastructure environment 100 can operate on a cloud computing infrastructure 102 comprising hardware (e.g., processor, memory), software resources, and one or more cloud interfaces 104 or other application program interfaces (API) that provide access to the shared cloud resources via one or more load balancers 106.

In accordance with an embodiment, the cloud infrastructure environment supports the use of availability domains, such as, for example, availability domains A 180, B 182, which enables customers to create and access cloud networks 184, 186, and run cloud instances A 192, B 194.

In accordance with an embodiment, a tenancy can be created for each cloud tenant/customer, for example tenant A 142, B 144, which provides a secure and isolated partition within the cloud infrastructure environment within which the customer can create, organize, and administer their cloud resources. A cloud tenant/customer can access an availability domain and a cloud network to access each of their cloud instances.

In accordance with an embodiment, a client device, such as, for example, a computing device 160 having a device hardware 162 (e.g., processor, memory), and graphical user interface 166, can enable an administrator other user to communicate with the cloud infrastructure environment via a network such as, for example, a wide area network, local area network, or the Internet, to create or update cloud services.

In accordance with an embodiment, the cloud infrastructure environment provides access to shared cloud resources 140 via, for example, a compute resources layer 150, a network resources layer 164, and/or a storage resources layer 170. Customers can launch cloud instances as needed, to meet compute and application requirements. After a customer provisions and launches a cloud instance, the provisioned cloud instance can be accessed from, for example, a client device.

In accordance with an embodiment, the compute resources layer can comprise resources, such as, for example, bare metal cloud instances 152, virtual machines 154, graphical processing unit (GPU) compute cloud instances 156, and/or containers 158. The compute resources layer can be used to, for example, provision and manage bare metal compute cloud instances, or provision cloud instances as needed to deploy and run applications, as in an on-premises data center.

For example, in accordance with an embodiment, the cloud infrastructure environment can provide control of physical host (bare metal) machines within the compute resources layer, which run as compute cloud instances directly on bare metal servers, without a hypervisor.

In accordance with an embodiment, the cloud infrastructure environment can also provide control of virtual machines within the compute resources layer, which can be launched, for example, from an image, wherein the types and quantities of resources available to a virtual machine cloud instance can be determined, for example, based upon the image that the virtual machine was launched from.

In accordance with an embodiment, the network resources layer can comprise a number of network-related resources, such as, for example, virtual cloud networks (VCNs) 165, load balancers 167, edge services 168, and/or connection services 169.

In accordance with an embodiment, the storage resources layer can comprise a number of resources, such as, for example, data/block volumes 172, file storage 174, object storage 176, and/or local storage 178.

As illustrated in FIG. 2, in accordance with an embodiment, the cloud infrastructure environment can include a range of complementary cloud-based components, for example as cloud infrastructure applications and services 200, that enable organizations or enterprise customers to operate their applications and services in a highly-available hosted environment.

By way of example, in accordance with an embodiment, a self-contained cloud region can be provided as a complete, e.g., Oracle Cloud Infrastructure (OCI) dedicated region within an organization's data center that offers the data center operator the agility, scalability, and economics of a public cloud, while retaining full control of their data and applications to meet security, regulatory, or data residency requirements.

For example, in accordance with an embodiment, such an environment can include racks physically and managed by a cloud infrastructure provider; customer's racks; access for cloud operations personnel for setup and hardware support; customer's data center power and cooling; customer's floor space; an area for customer's data center personnel; and a physical access cage.

In accordance with an embodiment, a dedicated region offers to a tenant/customer the same set of infrastructure-as-a-service (IaaS), platform-as-a-service (PaaS), and software-as-a-service (SaaS) products or services available in the cloud infrastructure provider's public cloud regions, such as, for example, ERP, Financials, HCM, and SCM. A customer can seamlessly lift and shift legacy workloads using the cloud infrastructure provider's services, for example bare metal compute, VMs, and GPUs; database services, for example Autonomous Database; or container-based services, for example Container Engine for Kubernetes.

In accordance with an embodiment, a cloud infrastructure environment can operate according to infrastructure-as-a-service (IaaS) model that enables the environment to provide virtualized computing resources over a public network (e.g., the Internet).

In an IaaS model, a cloud infrastructure provider can host the infrastructure components (e.g., servers, storage devices, network nodes (e.g., hardware), deployment software, platform virtualization (e.g., a hypervisor layer), or the like). In some cases, a cloud infrastructure provider may also supply a variety of services to accompany those infrastructure components (example services include billing software, monitoring software, logging software, load balancing software, or clustering software). Thus, as these services may be policy-driven, IaaS users may be able to implement policies to drive load balancing to maintain application availability and performance.

In accordance with an embodiment, IaaS customers may access resources and services through a wide area network (WAN), such as the Internet, and can use the cloud infrastructure provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, or managing disaster recovery.

In accordance with an embodiment, a cloud infrastructure provider may, but need not be, a third-party service that specializes in providing (e.g., offering, renting, selling) IaaS. An entity might also opt to deploy a private cloud, becoming its own provider of infrastructure services.

In accordance with an embodiment, IaaS deployment is the process of putting a new application, or a new version of an application, onto a prepared application server or the like. It may also include the process of preparing the server (e.g., installing libraries, or daemons). This is often managed by the cloud infrastructure provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like.

In accordance with an embodiment, IaaS provisioning may refer to acquiring computers or virtual hosts for use, and even installing needed libraries or services on them. In most cases, deployment does not include provisioning, and the provisioning may need to be performed first.

In accordance with an embodiment, challenges for IaaS provisioning include the initial challenge of provisioning the initial set of infrastructure before anything is running. Second, there is the challenge of evolving the existing infrastructure (e.g., adding new services, changing services, or removing services) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In accordance with an embodiment, a cloud infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more infrastructure elements are desired and/or added, the infrastructure may incrementally evolve.

In accordance with an embodiment, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

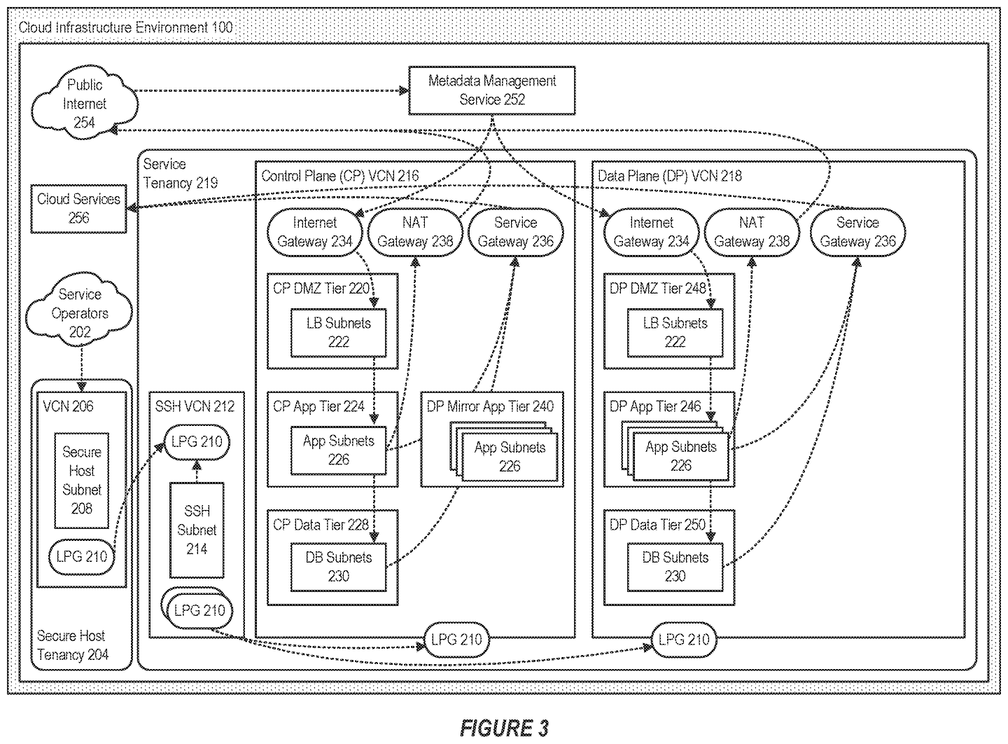

FIG. 3 illustrates an example cloud infrastructure architecture, in accordance with an embodiment.

As illustrated in FIG. 3, in accordance with an embodiment, service operators 202 can be communicatively coupled to a secure host tenancy 204 that can include a virtual cloud network (VCN) 206 and a secure host subnet 208.

In some examples, the service operators may be using one or more client computing devices, which may be portable handheld devices (e.g., a telephone, a computing tablet, a personal digital assistant (PDA)) or wearable devices (e.g., a head mounted display), running software such as Microsoft Windows, and/or a variety of mobile operating systems such as iOS, Android, and the like, and being Internet, e-mail, short message service (SMS), or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Chrome. Alternatively, or in addition, client computing devices may be any other electronic device, such as a thin-client computer, an Internet-enabled gaming system (e.g., a Microsoft Xbox gaming console), and/or a personal messaging device, capable of communicating over a network that can access the VCN and/or the Internet.

In accordance with an embodiment, a VCN can include a local peering gateway (LPG) 210 that can be communicatively coupled to a secure shell (SSH) VCN 212 via an LPG contained in the SSH VCN. The SSH VCN can include an SSH subnet 214, and the SSH VCN can be communicatively coupled to a control plane VCN 216 via the LPG contained in the control plane VCN. Also, the SSH VCN can be communicatively coupled to a data plane VCN 218 via an LPG. The control plane VCN and the data plane VCN can be contained in a service tenancy 219 that can be owned and/or operated by the cloud infrastructure provider.

In accordance with an embodiment, a control plane VCN can include a control plane demilitarized zone (DMZ) tier 220 that acts as a perimeter network (e.g., portions of a corporate network between the corporate intranet and external networks). The DMZ-based servers may have restricted responsibilities that help contain potential breaches. Additionally, the DMZ tier can include one or more load balancer (LB) subnet(s) 222, a control plane app tier 224 that can include app subnet(s) 226, and a control plane data tier 228 that can include database (DB) subnet(s) 230 (e.g., frontend DB subnet(s) and/or backend DB subnet(s)). The LB subnet(s) contained in the control plane DMZ tier can be communicatively coupled to the app subnet(s) contained in the control plane app tier, and an Internet gateway 234 that can be contained in the control plane VCN, and the app subnet(s) can be communicatively coupled to the DB subnet(s) contained in the control plane data tier and a service gateway 236 and a network address translation (NAT) gateway 238. The control plane VCN can include the service gateway and the NAT gateway.

In accordance with an embodiment, the control plane VCN can include a data plane mirror app tier 240 that can include app subnet(s). The app subnet(s) contained in the data plane mirror app tier can include a virtual network interface controller (VNIC) that can execute a compute instance. The compute instance can communicatively couple the app subnet(s) of the data plane mirror app tier to app subnet(s) that can be contained in a data plane app tier.

In accordance with an embodiment, the data plane VCN can include the data plane app tier 246, a data plane DMZ tier 248, and a data plane data tier 250. The data plane DMZ tier can include LB subnet(s) that can be communicatively coupled to the app subnet(s) of the data plane app tier and the Internet gateway of the data plane VCN. The app subnet(s) can be communicatively coupled to the service gateway of the data plane VCN and the NAT gateway of the data plane VCN. The data plane data tier can also include the DB subnet(s) that can be communicatively coupled to the app subnet(s) of the data plane app tier.

In accordance with an embodiment, the Internet gateway of the control plane VCN and of the data plane VCN can be communicatively coupled to a metadata management service 252 that can be communicatively coupled to the public Internet 254. The public Internet can be communicatively coupled to the NAT gateway of the control plane VCN and of the data plane VCN. The service gateway of the control plane VCN and of the data plane VCN can be communicatively coupled to cloud services 256.

In accordance with an embodiment, the service gateway of the control plane VCN, or of the data plane VCN, can make application programming interface (API) calls to cloud services without going through the public Internet. The API calls to cloud services from the service gateway can be one-way: the service gateway can make API calls to cloud services, and cloud services can send requested data to the service gateway. Generally, cloud services may not initiate API calls to the service gateway.

In accordance with an embodiment, the secure host tenancy can be directly connected to the service tenancy, which may be otherwise isolated. The secure host subnet can communicate with the SSH subnet through an LPG that may enable two-way communication over an otherwise isolated system. Connecting the secure host subnet to the SSH subnet may give the secure host subnet access to other entities within the service tenancy.

In accordance with an embodiment, the control plane VCN may allow users of the service tenancy to set up or otherwise provision desired resources. Desired resources provisioned in the control plane VCN may be deployed or otherwise used in the data plane VCN. In some examples, the control plane VCN can be isolated from the data plane VCN, and the data plane mirror app tier of the control plane VCN can communicate with the data plane app tier of the data plane VCN via VNICs that can be contained in the data plane mirror app tier and the data plane app tier.

In accordance with an embodiment, users of the system, or customers, can make requests, for example create, read, update, or delete (CRUD) operations, through the public Internet that can communicate the requests to the metadata management service. The metadata management service can communicate the request to the control plane VCN through the Internet gateway. The request can be received by the LB subnet(s) contained in the control plane DMZ tier. The LB subnet(s) may determine that the request is valid, and in response to this determination, the LB subnet(s) can transmit the request to app subnet(s) contained in the control plane app tier. If the request is validated and requires a call to the public Internet, the call to the Internet may be transmitted to the NAT gateway that can make the call to the Internet. Metadata to be stored by the request can be stored in the DB subnet(s).

In accordance with an embodiment, the data plane mirror app tier can facilitate direct communication between the control plane VCN and the data plane VCN. For example, changes, updates, or other suitable modifications to configuration may be desired to be applied to the resources contained in the data plane VCN. By means of a VNIC, the control plane VCN can directly communicate with, and can thereby execute the changes, updates, or other suitable modifications to configuration to, resources contained in the data plane VCN.

In accordance with an embodiment, the control plane VCN and the data plane VCN can be contained in the service tenancy. In this case, the user, or the customer, of the system may not own or operate either the control plane VCN or the data plane VCN. Instead, the cloud infrastructure provider may own or operate the control plane VCN and the data plane VCN, both of which may be contained in the service tenancy. This embodiment can enable isolation of networks that may prevent users or customers from interacting with the resources of other users or other customers. Also, this embodiment may allow users or customers of the system to store databases privately without needing to rely on the public Internet for storage, which may not provide a desired level of threat prevention.

In accordance with an embodiment, the LB subnet(s) contained in the control plane VCN can be configured to receive a signal from the service gateway. In this embodiment, the control plane VCN and the data plane VCN may be configured to be called by a customer of the cloud infrastructure provider without calling the public Internet. Customers of the cloud infrastructure provider may desire this embodiment since the database(s) that the customers use may be controlled by the cloud infrastructure provider and may be stored on the service tenancy, which may be isolated from the public Internet.

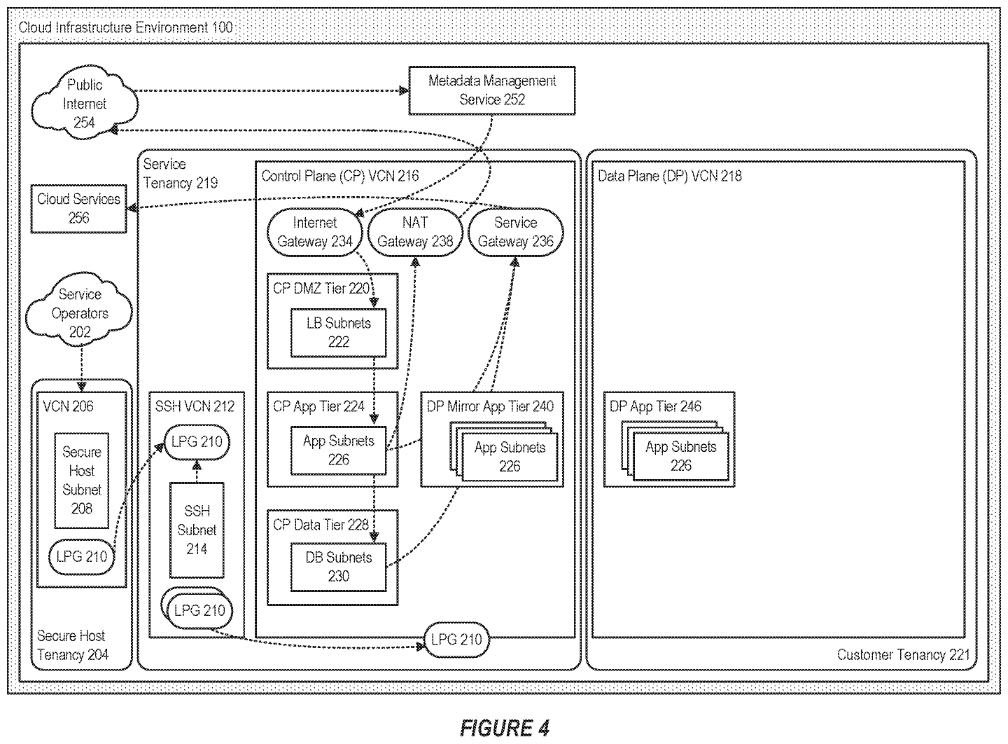

FIG. 4 illustrates another example of a cloud infrastructure architecture, in accordance with an embodiment.

As illustrated in FIG. 4, in accordance with an embodiment, the data plane VCN can be contained in the customer tenancy 221. In this case, the cloud infrastructure provider may provide the control plane VCN for each customer, and the cloud infrastructure provider may, for each customer, set up a unique compute instance that is contained in the service tenancy. Each compute instance may allow communication between the control plane VCN, contained in the service tenancy, and the data plane VCN that is contained in the customer tenancy. The compute instance may allow resources that are provisioned in the control plane VCN that is contained in the service tenancy, to be deployed or otherwise used in the data plane VCN that is contained in the customer tenancy.

In accordance with an embodiment, a customer of the cloud infrastructure provider may have databases that are managed and operate within the customer tenancy. In this example, the control plane VCN can include the data plane mirror app tier that can include app subnet(s). The data plane mirror app tier can reside in the data plane VCN, but the data plane mirror app tier may not be provided in the data plane VCN. That is, the data plane mirror app tier may have access to the customer tenancy, but the data plane mirror app tier may not exist in the data plane VCN or be owned or operated by the customer. The data plane mirror app tier may be configured to make calls to the data plane VCN, but may not be configured to make calls to any entity contained in the control plane VCN. The customer may desire to deploy or otherwise use resources in the data plane VCN that are provisioned in the control plane VCN, and the data plane mirror app tier can facilitate the desired deployment, or other usage of resources, of the customer.

In accordance with an embodiment, a customer of the cloud infrastructure provider can apply filters to the data plane VCN. In this embodiment, the customer can determine what the data plane VCN can access, and the customer may restrict access to the public Internet from the data plane VCN. The cloud infrastructure provider may not be able to apply filters or otherwise control access of the data plane VCN to any outside networks or databases. Applying filters and controls by the customer onto the data plane VCN, contained in the customer tenancy, can help isolate the data plane VCN from other customers and from the public Internet.

In accordance with an embodiment, cloud services can be called by the service gateway to access services that may not exist on the public Internet, on the control plane VCN, or on the data plane VCN. The connection between cloud services and the control plane VCN or the data plane VCN may not be continuous. Cloud services may exist on a different network owned or operated by the cloud infrastructure provider. Cloud services may be configured to receive calls from the service gateway and may be configured to not receive calls from the public Internet. Some cloud services may be isolated from other cloud services, and the control plane VCN may be isolated from cloud services that may not be in the same region as the control plane VCN.

For example, in accordance with an embodiment, the control plane VCN may be located in a “Region 1,” and a cloud service “Deployment 1,” may be located in Region 1 and in “Region 2.” If a call to Deployment 1 is made by the service gateway contained in the control plane VCN located in Region 1, the call may be transmitted to Deployment 1 in Region 1. In this example, the control plane VCN, or Deployment 1 in Region 1, may not be communicatively coupled to, or otherwise in communication with Deployment 1 in Region 2.

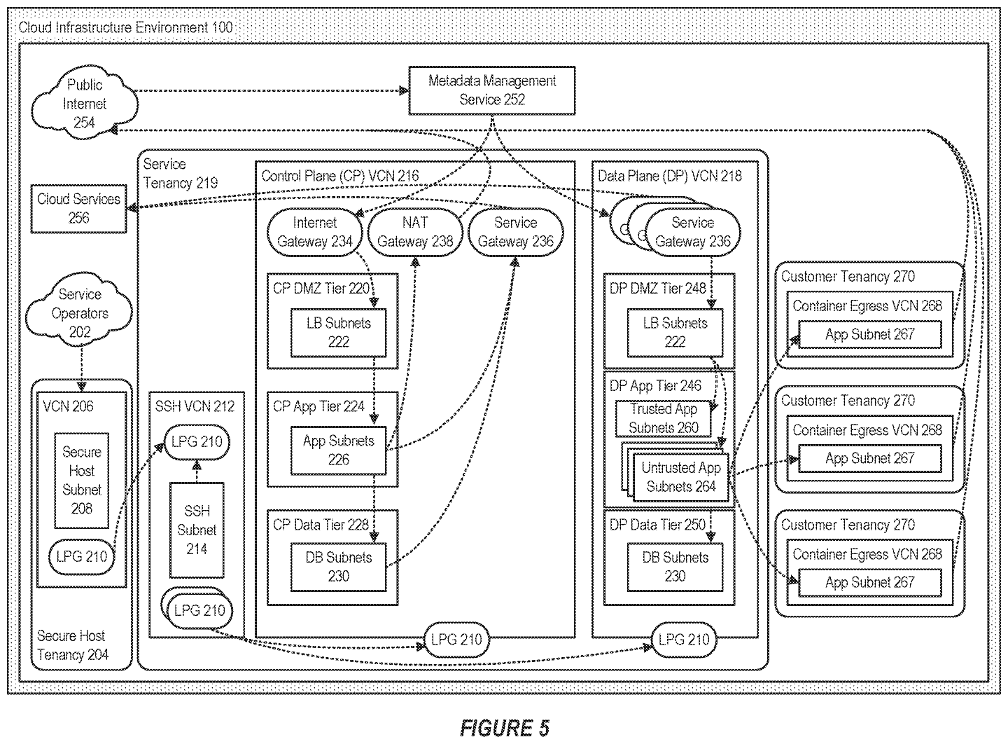

FIG. 5 illustrates another example of a cloud infrastructure architecture, in accordance with an embodiment.

As illustrated in FIG. 5, in accordance with an embodiment, the trusted app subnet(s) 260 can be communicatively coupled to the service gateway contained in the data plane VCN, the NAT gateway contained in the data plane VCN, and DB subnet(s) contained in the data plane data tier. The untrusted app subnet(s) 264 can be communicatively coupled to the service gateway contained in the data plane VCN and DB subnet(s) contained in the data plane data tier. The data plane data tier can include DB subnet(s) that can be communicatively coupled to the service gateway contained in the data plane VCN.

In accordance with an embodiment, untrusted app subnet(s) can include one or more primary VNICs (1)-(N) that can be communicatively coupled to tenant virtual machines (VMs). Each tenant VM can be communicatively coupled to a respective app subnet 267 (1)-(N) that can be contained in respective container egress VCNs 268 (1)-(N) that can be contained in respective customer tenancies 270 (1)-(N). Respective secondary VNICs can facilitate communication between the untrusted app subnet(s) contained in the data plane VCN and the app subnet contained in the container egress VCN. Each container egress VCN can include a NAT gateway that can be communicatively coupled to the public Internet.

In accordance with an embodiment, the public Internet can be communicatively coupled to the NAT gateway contained in the control plane VCN and contained in the data plane VCN. The service gateway contained in the control plane VCN and contained in the data plane VCN can be communicatively coupled to cloud services.

In accordance with an embodiment, the data plane VCN can be integrated with customer tenancies. This integration can be useful or desirable for customers of the cloud infrastructure provider in cases that may require additional support when executing code. For example, the customer may provide code to run that may be potentially destructive, may communicate with other customer resources, or may otherwise cause undesirable effects.

In accordance with an embodiment, a customer of the cloud infrastructure provider may grant temporary network access to the cloud infrastructure provider and request a function to be attached to the data plane app tier. Code to run the function may be executed in the VMs, and may not be configured to run anywhere else on the data plane VCN. Each VM may be connected to one customer tenancy. Respective containers (1)-(N) contained in the VMs may be configured to run the code. In this case, there can be a dual isolation (e.g., the containers running code, where the containers may be contained in at least the VM that are contained in the untrusted app subnet(s)), which may help prevent incorrect or otherwise undesirable code from damaging the network of the cloud infrastructure provider or from damaging a network of a different customer. The containers may be communicatively coupled to the customer tenancy and may be configured to transmit or receive data from the customer tenancy. The containers may not be configured to transmit or receive data from any other entity in the data plane VCN. Upon completion of running the code, the cloud infrastructure provider may dispose of the containers.

In accordance with an embodiment, the trusted app subnet(s) may run code that may be owned or operated by the cloud infrastructure provider. In this embodiment, the trusted app subnet(s) may be communicatively coupled to the DB subnet(s) and be configured to execute CRUD operations in the DB subnet(s). The untrusted app subnet(s) may be communicatively coupled to the DB subnet(s), and configured to execute read operations in the DB subnet(s). The containers that can be contained in the VM of each customer and that may run code from the customer may not be communicatively coupled with the DB subnet(s).

In accordance with an embodiment, the control plane VCN and the data plane VCN may not be directly communicatively coupled; or there may be no direct communication between the control plane VCN and the data plane VCN. However, communication can occur indirectly, wherein an LPG may be established by the cloud infrastructure provider that can facilitate communication between the control plane VCN and the data plane VCN. In another example, the control plane VCN or the data plane VCN can make a call to cloud services via the service gateway. For example, a call to cloud services from the control plane VCN can include a request for a service that can communicate with the data plane VCN.

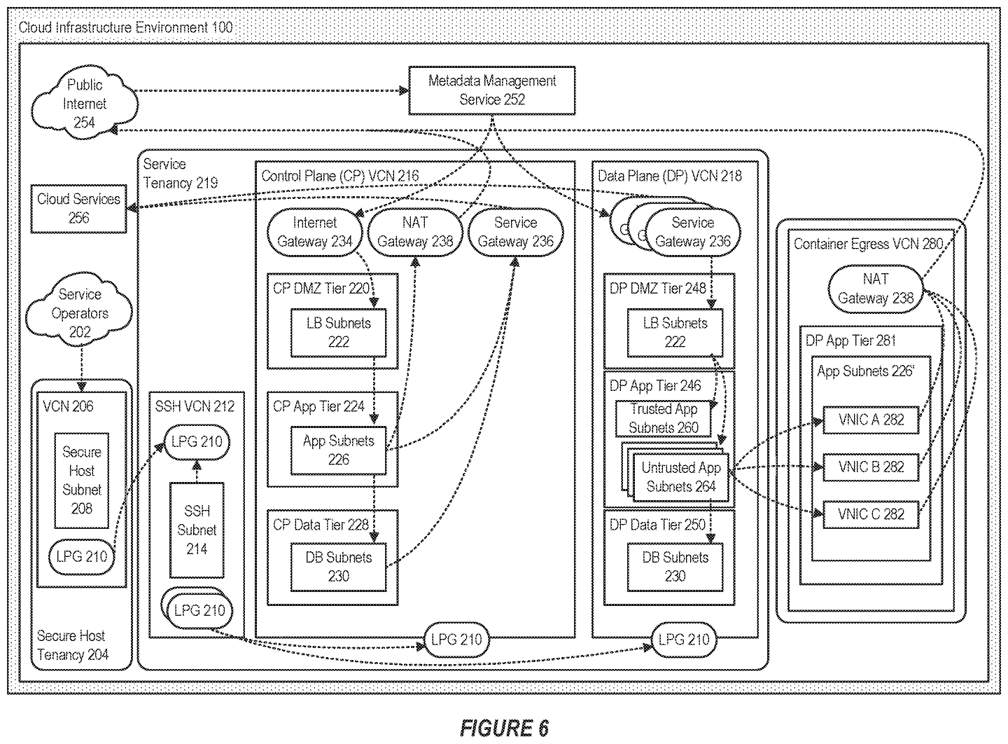

FIG. 6 illustrates another example of a cloud infrastructure architecture, in accordance with an embodiment.

As illustrated in FIG. 6, in accordance with an embodiment, the trusted app subnet(s) can be communicatively coupled to the service gateway contained in the data plane VCN, the NAT gateway contained in the data plane VCN, and DB subnet(s) contained in the data plane data tier. The untrusted app subnet(s) can be communicatively coupled to the service gateway contained in the data plane VCN and DB subnet(s) contained in the data plane data tier. The data plane data tier can include DB subnet(s) that can be communicatively coupled to the service gateway contained in the data plane VCN.

In accordance with an embodiment, untrusted app subnet(s) can include primary VNICs that can be communicatively coupled to tenant virtual machines (VMs) residing within the untrusted app subnet(s). Each tenant VM can run code in a respective container, and be communicatively coupled to an app subnet that can be contained in a data plane app tier 281 that can be contained in a container egress VCN 280. Respective secondary VNICs 282 (1)-(N) can facilitate communication between the untrusted app subnet(s) contained in the data plane VCN and the app subnet contained in the container egress VCN. The container egress VCN can include a NAT gateway that can be communicatively coupled to the public Internet.

In accordance with an embodiment, the Internet gateway contained in the control plane VCN and contained in the data plane VCN can be communicatively coupled to a metadata management service that can be communicatively coupled to the public Internet. The public Internet can be communicatively coupled to the NAT gateway contained in the control plane VCN and contained in the data plane VCN. The service gateway contained in the control plane VCN and contained in the data plane VCN can be communicatively coupled to cloud services.

In accordance with an embodiment, the pattern illustrated in FIG. 6 may be considered an exception to the pattern illustrated in FIG. 5 and may be desirable for a customer if the cloud infrastructure provider cannot directly communicate with the customer (e.g., a disconnected region). The respective containers that are contained in the VMs for each customer can be accessed in real-time by the customer. The containers may be configured to make calls to respective secondary VNICs contained in app subnet(s) of the data plane app tier that can be contained in the container egress VCN. The secondary VNICs can transmit the calls to the NAT gateway that may transmit the calls to the public Internet. In this example, the containers that can be accessed in real-time by the customer can be isolated from the control plane VCN and can be isolated from other entities contained in the data plane VCN. The containers may also be isolated from resources from other customers.

In other examples, the customer can use the containers to call cloud services. In this example, the customer may run code in the containers that requests a service from cloud services. The containers can transmit this request to the secondary VNICs that can transmit the request to the NAT gateway that can transmit the request to the public Internet. The public Internet can be used to transmit the request to LB subnet(s) contained in the control plane VCN via the Internet gateway. In response to determining the request is valid, the LB subnet(s) can transmit the request to app subnet(s) that can transmit the request to cloud services via the service gateway.

It should be appreciated that IaaS architectures depicted in the above figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner.

### Cloud Environments

In accordance with an embodiment, a cloud infrastructure environment can be used to provide dedicated cloud environments, for example as one or more private label cloud environments, for use by tenants of the cloud infrastructure environment in accessing subscription-based software products, services, or other offerings associated with the cloud infrastructure environment.

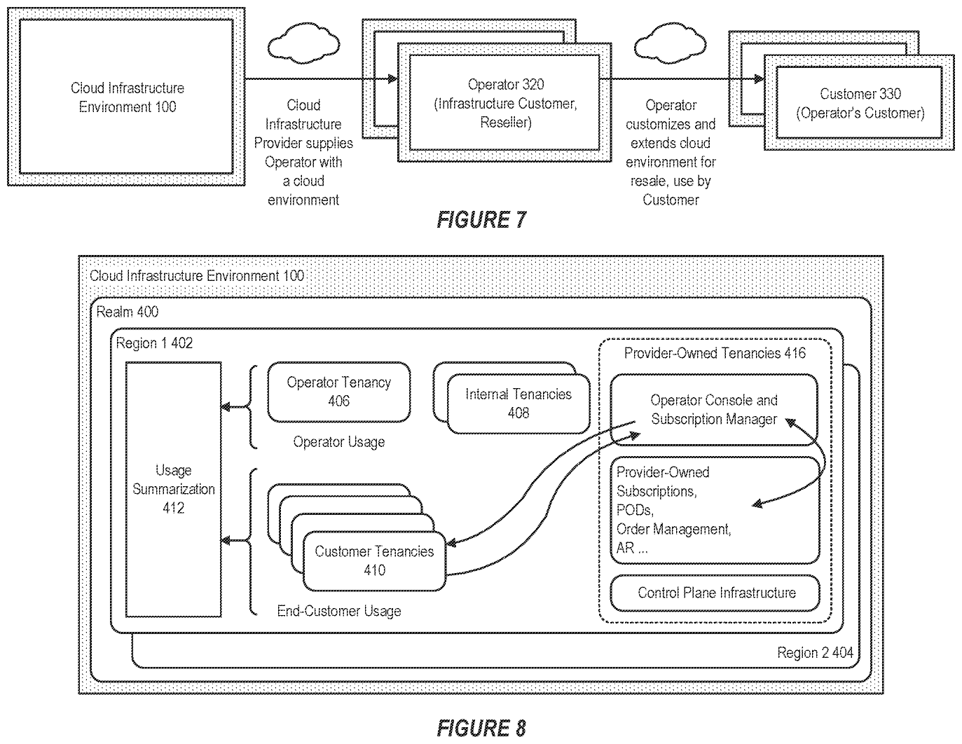

FIG. 7 illustrates how the system can provide dedicated or private label cloud environments, for use by tenants or customers of a cloud infrastructure environment, in accordance with an embodiment.

Although several of the examples described herein illustrate various systems, methods, and/or techniques as may be used in the context of providing private label cloud (PLC) environments, in accordance with various embodiments, the systems, methods, and techniques described herein can be used, within or with other types of cloud environments.

As illustrated in FIG. 7, in accordance with an embodiment, a cloud infrastructure provider can supply an operator 320, for example a cloud infrastructure customer operating as a reseller, with one or more cloud environments (e.g., a PLC environment) or realms. The operator/reseller can then customize and extend the cloud environment for use by (their) customer 330, for use in accessing subscription-based software products, services, or other offerings associated with the cloud infrastructure environment.

For purposes of illustration, examples of such subscription-based products, services, or other offerings may include various cloud infrastructure software products, such as Oracle Fusion Applications products, or other types of products or services that allow customers to subscribe to usage of those products or services.

FIG. 8 further illustrates the use of cloud realms, for use by tenants or customers of a cloud infrastructure environment, in accordance with an embodiment.

As illustrated in FIG. 8, in accordance with an embodiment, the system can include a cloud subscription service or component, referred to herein in some embodiments as a subscription manager, that exposes one or more subscription management APIs for creating orders used to onboard new customers, or to launch a workflow that creates a subscription and orchestrates billing and pricing service or other components for use with a cloud realm 400.

In accordance with an embodiment, when an operator (e.g., a PLC operator) or their customer requests a cloud environment, the system creates a realm, for use within a region 402, 404; together with one or more provider-owned tenancies 416. These tenancies allow a region to function with its required service infrastructure; and are administered by the cloud infrastructure provider.

In accordance with an embodiment, a first step in the process is to create an operator tenancy 406 for the operator, before the region and associated realms are turned over to them for subsequent management. The operator then becomes the administrator of this tenancy, within which they can view and manage everything that happens within that region, including their customer accounts and usage 412 by those customers of cloud resources.

Generally, once the region has been turned over or provided to the operator, the cloud infrastructure provider cannot subsequently access the data within the operator tenancy, unless the operator authorizes the cloud infrastructure provider to do so, for example to provide troubleshooting of issues that may arise.

In accordance with an embodiment, the operator can then create additional internal tenancies 408, intended for their own use internally, for example to assess what the end user or customer experience will be, or to provide a sales demo tenancy, or to operate a database for their own internal use. The operator can also create one or more customer tenancies 410, of which the end user or customer will be the administrator. Cloud infrastructure usage, for example compute, storage, and other infrastructure resources, is consolidated by operator, reflecting both their usage and that of their customers, and reported to the cloud infrastructure provider.

In accordance with an embodiment, a user interface or console can be provided that allows the operator to manage its customer accounts and customer-offered services. A cloud infrastructure provider can also use a cloud infrastructure tenancy, for example a Fusion Applications tenancy, to install any needed infrastructure services for use by the operator and their customers.

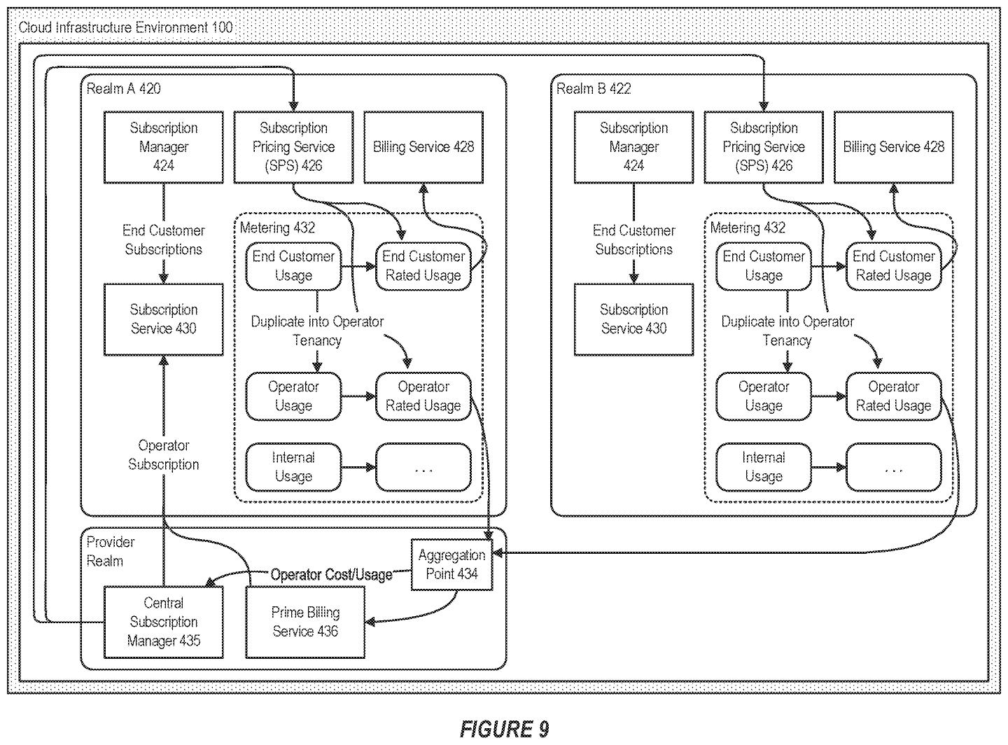

FIG. 9 further illustrates the use of cloud realms, for use by tenants or customers of a cloud infrastructure environment, in accordance with an embodiment.

As illustrated in FIG. 9, in accordance with an embodiment, a subscription manager 424 service or component exposes one or more subscription management APIs for creating orders used to onboard new customers, or to launch a workflow that creates a subscription and orchestrates billing and pricing service or other components.

In accordance with an embodiment, the system can also include a billing service 428 or component that operates upon a billing account or logical container of subscriptions and preferences used to produce an invoice for a customer.

In accordance with an embodiment, the system can also include a subscription pricing service (SPS) 426 or component, which operates upon a product catalog that defines which products can be purchased by a customer, and can be used to provide a price list (e.g., a rate card) that the pricing service also owns.

In accordance with an embodiment, to support the sales process through which a subscription is created in a realm 420, 422, products can be selected from a product hub. Once an order is created via a subscription service 430, a subscription is created in the subscription manager which thereafter manages the life cycle of that subscription, and provisions what needs to be provisioned in downstream services. The SPS component then manages the aspects of pricing and usage, for use in charging the end cost to the operator or their ability to charge their customers. Usage events are forwarded to the billing service or component, where depending on the billing preferences of the subscription, invoices are created and pushed to an accounts receivables component.

In accordance with an embodiment, although the services that are offered in a realm report their usage to a metering service or component 432, such usage does not have any price associated with it. A rating process determines how much each specific event costs, for example by applying rate cards, determines a unit and cost for that subscription, associates the cost to that record, and then forwards that to the billing service or component.

As further illustrated in FIG. 9, in accordance with an embodiment, an operator may control multiple realms A, B—for example an operator that operates in multiple countries may wish to operate a data center that is completely isolated for the United States of America, and a separate data center that is completely isolated for Europe, for example to address governance or regulatory requirements. In accordance with an embodiment, the usage associated with these multiple realms can be aggregated 434, for use by a central subscription manager 435, and where applicable a prime billing service 436, in billing the operator.

The examples of various systems illustrated above are provided for purposes of illustrating a computing environment which can be used to provide dedicated or private label cloud environments, for use by tenants of a cloud infrastructure in accessing subscription-based software products, services, or other offerings associated with the cloud infrastructure environment. In accordance with other embodiments, the various components, processes, and features described herein can be used with other types of cloud computing environments.

### Cloud Subscriptions

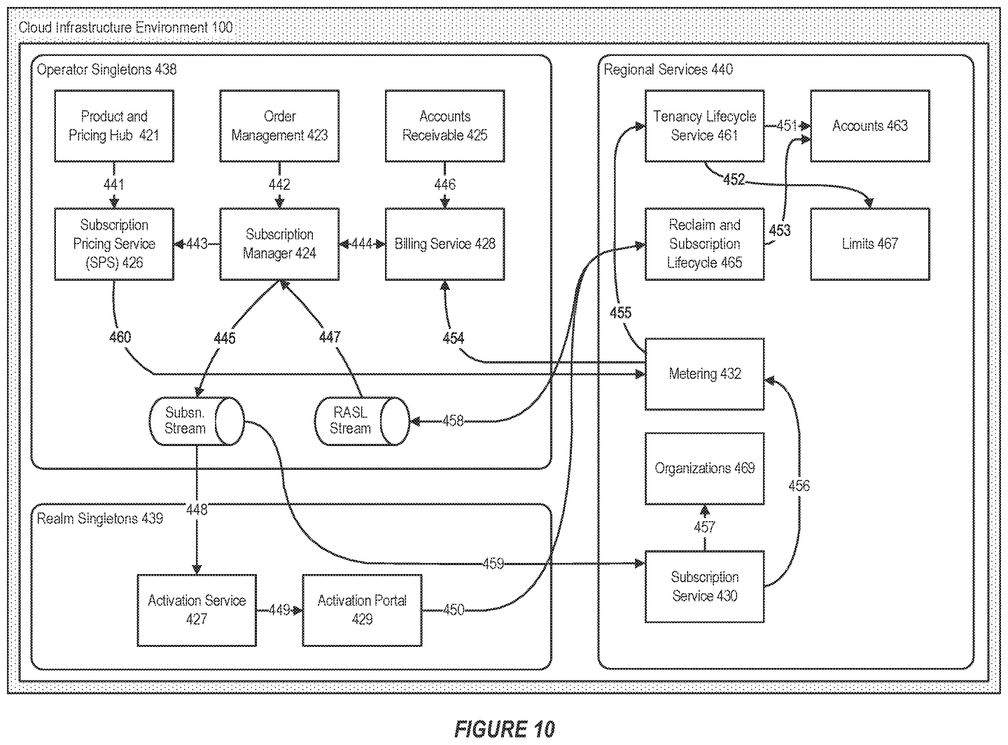

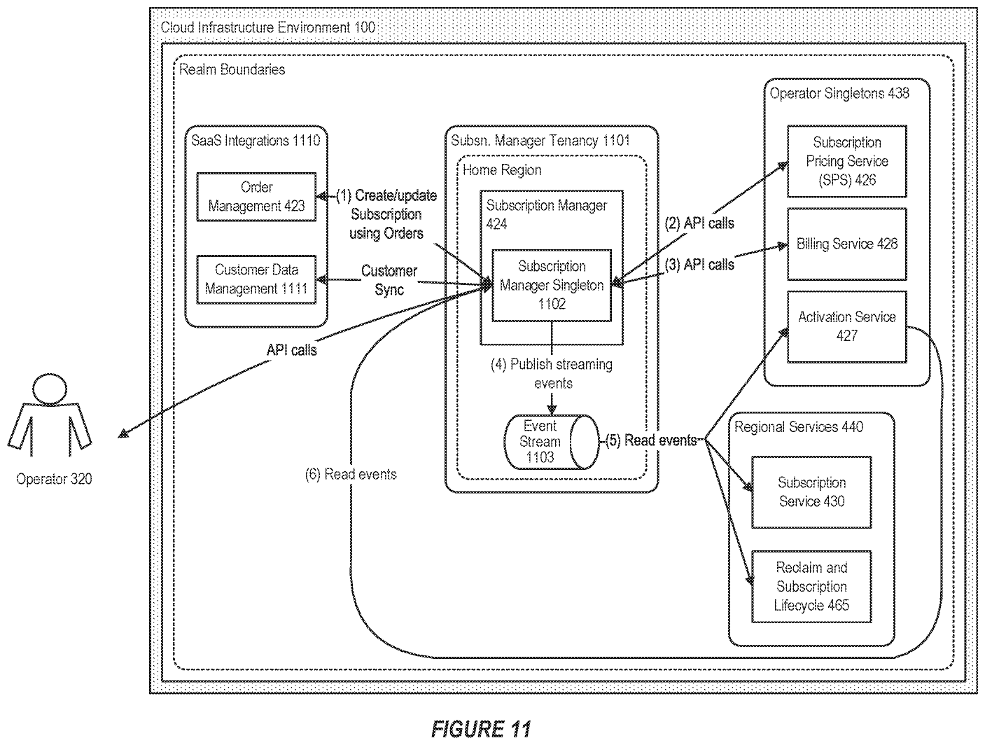

FIG. 10 illustrates a system for providing access to software products or services in a cloud computing or other computing environment, in accordance with an embodiment.

As illustrated in FIG. 10, in accordance with an embodiment, the system can be provided as a cloud computing or other computing environment, referred to herein in some embodiments as a platform, that supports the use of subscription-based products, services, or other offerings.

Examples of such subscription-based products, services, or other offerings may include various cloud infrastructure software products or services that allow customers to subscribe to usage of those products or services.

In accordance with an embodiment, the environment can include a plurality of components provided as operator singletons 438, realm singletons 439, and regional services 440, as further described below.

In accordance with an embodiment, a subscription can include artifacts such as, for example, products, commits, billing model, and state. The subscription manager service or component can expose one or more subscription management APIs for creating orders used to onboard new customers, or to launch a workflow that creates a subscription and orchestrates creating the proper footprints in billing and pricing service or components, as further described below.

In accordance with an embodiment, the billing service or component operates upon a billing account or logical container of subscriptions and preferences used to produce an invoice. Each billing account generates one invoice per billing cycle. The billing service includes a first pipeline that accepts usage and cost from a metering service or component through a REST API, wherein billing writes the usage to a database from which billing workers aggregate and calculate balances; and a second pipeline responsible for taking the aggregated usage and commitments and calculating charges over a billing interval.

In accordance with an embodiment, the subscription pricing service (SPS) 426 or component operates upon a product catalog that defines which products can be purchased by a customer. The product catalog forms the backbone of a price list (i.e., rate card) that the pricing service also owns. Rate cards are modeled as pricing rules on top of public list prices. The pricing service maintains a single price list for all products, new product prices can be added, and existing prices changed. The price list has a full history, the latest version being the current rate card. Since some contracts may require a snapshot of the rate card be taken, the pricing service handles this by recording the time a customer's rate card is created, and then querying the price list at that time.

In accordance with an embodiment, the SPS or pricing service is responsible for communicating with a product and pricing hub 421, to provide information about products, global price list, and end user or customer's subscription specific price lists and discounts. For example, in accordance with an embodiment, SPS can synchronize product information from a product hub, and a global price list from a pricing hub.

In accordance with an embodiment, the subscription manager service or component operates as an upstream service to receive new order requests from an order management 423 component, for example from an Oracle Fusion Order Management environment. The subscription manager service or component can provide subscription information to the SPS service, including subscription details such as time of quote configured, or subscription type (Commitment, PayG), to help SPS to determine an effective base price (Rate Card) for the subscription. The subscription manager service or component can also send discounts for subscriptions received from the order management component, which SPS stores as a pricing rule entity.

In accordance with an embodiment, the SPS service runs as a background process to manage a rate cards service or component, which is responsible for generating rate cards for new subscriptions and updating those rate cards when new price changes occur. The SPS service can provide APIs to access rate cards and pricing rules. A metering in-line rating engine can utilize these APIs to obtain subscription-specific rate cards and pricing rules, and then use this data for cost calculations.

In accordance with an embodiment, additional SPS components can include, for example, a pricing/product hub integration component, that allows an operator entity providing subscription-based products, services, or other offerings within the environment, to manage their product and price list, for example as provided by a product hub and pricing hub respectively.

For example, in accordance with such an embodiment, an SPS product integration flow can listen to create/update events in the product hub and make calls to an SPS product API. Similarly, an SPS pricing integration flow can pull new price list creation from the pricing hub and call respective SPS pricing APIs.

In accordance with an embodiment, the system can also include an SPS core module that provides APIs to manage and access pricing entities. Pricing entities can be accessed by internal services, for example an inline rating engine.

In accordance with an embodiment, the system can also include a rate card manager component. The SPS service maintains the single base price for a product at a given time. However, product prices for subscription are dependent on a base price at quote configuration time and price list change policy attributes of subscriptions. The SPS service internally maintains the price to be used for subscription using these properties. All such price lists are grouped in a rate card. The rate card manager can create and maintain the rate card, listen to price list changes and update existing rate cards with the new price, and listen to new subscriptions and assigns the rate card based on subscription properties.

In accordance with an embodiment, the SPS service is responsible for managing pricing rules for a subscription, including discounts offered to an end user or customer. Pricing rules eligibility can be based on attributes of products, such as discount group, product category or specific SKUs. Internally SPS needs to identify the list of products for which these rules will be applicable. To accomplish this, a rule decoder engine can compile the pricing rules in a format such that an in-line rating engine can consume the information for cost calculation. This compilation process can be triggered when products or pricing rules are created or updated.

As illustrated by way of example in FIG. 10, in accordance with an embodiment: at 441, a product and price information managed in, e.g., Fusion Applications, is sent to the SPS component.

At 442, orders are sent to the subscription manager component to create subscriptions, rate cards and billing accounts.

At 443, pricing configuration and pricing rules are sent to SPS for new orders.

At 444, the subscription manager component is used to set up a billing account in the billing service or component.

At 445, the subscription manager component publishes events to an subscription manager streaming component.

At 446, a charge data is sent to an accounts receivable component 425 to generate invoices.

At 447, the subscription manager component consumes reclaim and subscription lifecycle (RASL) events from subscription manager streaming.

At 448, an activation service 427 reads the subscription manager event stream.

At 449, a customer obtains activation data from an activation portal 429.

At 450, a tenancy lifecycle service 461 provisions a tenancy as part of the subscription activation.

At 451, the tenancy lifecycle service creates, within an accounts 463 component, an accounts footprint during account provisioning.

At 452, the tenancy lifecycle service sets, within a limits service 467, a limits template during account provisioning.

At 453, the accounts component acts as a downstream RASL client to handle a legacy reclamation and subscription lifecycle 465.

At 454, aggregated cost and usage is sent to the billing service 428 or component.

At 455, an organization can create child tenancies using the tenancy lifecycle service.

At 456, a metering service 432 or component obtains subscription mapping data.

At 457, the subscription service 430 obtains organization data 469 for subscription mappings.

At 458, the RASL component reads the subscription manager event stream.

At 459, the subscription service reads the subscription manager event stream; and at 460, the metering service or component obtains a rate card data for each subscription, which can then be used in charging the end cost to the operator or their ability to charge their customers.

The above examples are provided for purposes of illustrating a computing environment which can be used to provide dedicated or private label cloud environments, for use by tenants of a cloud infrastructure in accessing subscription-based software products, services, or other offerings associated with the cloud infrastructure environment. In accordance with other embodiments, the various components, processes, and features described herein can be used with other types of cloud computing environments.

### Cloud Subscription Manager

In some environments, subscription management processes may include a variety of different calls and different processes that are chained together in a complex manner. The disclosed systems and methods provide a decoupling where the subscription manager emits and publishes events, and downstream services consume these published events.

In accordance with an embodiment, a cloud computing environment can provide services that span branding, commercial, and operational capabilities of the cloud computing environment. Realms can be provided therein, which can be, for example, associated with operators, which can be utilized to allow operators to provide to their customers services and other offerings of the cloud environment.

In accordance with an embodiment, the subscription manager can be utilized to create and manage subscriptions, such as the subscriptions of customers of the operators. In addition, the subscription manager can also be used internally to create and manage subscriptions of operators, as well as users of the cloud infrastructure environment. The subscription manager can allow operators to, for example have customers rapidly onboarded, as well as manage their own customers, and subscriptions independently of the cloud infrastructure environment provider.

In accordance with an embodiment, upon the determination of a lifecycle event associated with the subscription for a service, a stream event can be created and published to an event stream by the subscription manager. This stream event can be recorded by the subscription manager as an entry in a data store comprising the event stream managed by the subscription manager, and thereafter used in managing the subscription.

FIG. 11 illustrates a system for managing subscriptions associated with cloud services, in accordance with an embodiment.

As illustrated in FIG. 11, in accordance with an embodiment, the system can be provided as a cloud computing or other computing environment 100, referred to herein in some embodiments as a platform, that supports the use of subscription-based products, services, or other offerings.

Examples of such subscription-based products, services, or other offerings may include various cloud infrastructure software products or services that allow customers to subscribe to usage of those products or services.

In accordance with an embodiment, a realm, defined by realm boundaries, can be defined within the cloud infrastructure environment. The realm boundaries can be, for example, associated with an operator of the cloud infrastructure environment, and can be defined by, for example, a number of resources, services, and/or identities defined within the realm boundary. The realm boundaries can be defined within, for example, one region, or the realm can be defined to cross a plurality of regions. As an example, identities cannot be used to cross realms boundaries.

In accordance with an embodiment, as illustrated in FIG. 11, a subscription manager 424 service can be provided within a subscription manager tenancy 1101 that is defined within the realm. The subscription manager can expose one or more subscription management APIs for creating orders used to onboard new customers, or to launch a workflow that creates a subscription and orchestrates billing and pricing service or other components.

In accordance with an embodiment, the subscription manager 424 can be deployed as a singleton service 1102 within the home region of the realm in which the subscription manager is deployed, and the service 1102 can be associated with a database or a data store comprising a data stream of events, such as event stream 1103 which can be provided and maintained in, e.g., a datastore.

In accordance with an embodiment, within the realm there can be defined a number of services, such as a subscription pricing service 426, a billing service 428, an activation service 427, a subscription service 430, and a reclaim and subscription lifecycle service (RASL) 465. Some of these services can be deployed as singleton services 438, where such services are deployed once per operator. These services can include, for example, the subscription service, the billing service, and the activation service. Other services can be deployed, for example, on a regional basis, where the realm can span one or more regions. These regional services 440 can include, for example, the subscription service 430 and the reclaim and subscription lifecycle service 465.

In accordance with an embodiment, an integration, such as a SaaS integration 1110 can be deployed within the realm as well and can include an order management service 423 as well as a customer data management service 1111.

In accordance with an embodiment, the subscription manager 424 can be invoked each time a lifecycle change event occurs in connection with a subscription for a service provided by the cloud infrastructure environment in the context of the realm in which the subscription manager is deployed. FIG. 11 depicts, for example, an exemplary flow for such lifecycle events, such as the creation or modification (updating) of a subscription to such as service.

In accordance with an embodiment, at (1), an order management interface 423 of the SaaS integration 1110 (e.g., the SaaS integration comprises a service integration provided within the realm, such as a data analytics SaaS integration) can be utilized to initiate a lifecycle change to a service within the realm, such a new order is being sent to process in the subscription manager 424 from the order management 423.

In accordance with an embodiment, upon receiving the new order (e.g., an order for creation of a new service or an update/modification to an already deployed service), the subscription manager 324 can create subscriptions from the provided order. The subscription manager can create a pricing footprint that consists of subscription configuration as well as pricing rules. The subscription manager can also create a billing account for the subscription.

In accordance with an embodiment, the subscription manager 424 and the singleton service 1102 therein can be tightly-coupled to some of the services provided within the realm, such as the subscription pricing service 426 and the billing service 428. The subscription manager can communicate with these tightly-coupled services through API calls (2) and (3).

In accordance with an embodiment, in addition to supporting these calls (e.g., API calls) to some of the services of the realm, the subscription manager 424 and the singleton service 1102 associated therewith can populate the subscription manager event stream 1103 with published stream events (4).

In accordance with an embodiment, for example, upon the determination of a lifecycle event associated with the subscription for a service, there is a stream event that is created and published by the subscription manager. This stream event is published to the stream. For example, upon a customer of an operator creating a new subscription, the subscription manager publishes one or more associated events in an event stream maintained at the event stream 1103. These one or more events that are published to the stream can include, for example, an event for a value for the subscription, an event indicating that the processing for the subscription has been initiated, and another event indicating that processing for the subscription has been completed. In other words, the subscription manage publishes events related to the orders and subscription lifecycle changes to the stream at the datastore.

In accordance with an embodiment, conversely to the services that are tightly-coupled to the subscription manager, other services provided with the realm can be loosely-coupled to the subscription manager. These loosely-coupled services are indicated in FIG. 11 as comprising the activation service 427, the subscription service 430, and the reclaim and subscription lifecycle service 465. One of skill in the art would readily appreciate that there can be more or fewer services that can be loosely-coupled to the subscription manager.

In accordance with an embodiment, as opposed to initiating or receiving API calls from the subscription manager that the tightly-coupled services engage in, these loosely-coupled services instead read (5) the events that are published in the stream 1104. For example, Activation, Subscription service, and RASL consume events. Activation consumes order events, Subscription service and RASL consume subscription lifecycle changes events, and Subscription Activation and subscription suspend/resume notification through events.

In accordance with an embodiment, the subscription manager can read (6) events generated by the services. For example, activations can generate sent email events which the subscription manager uses as Revenue Recognition (Rev-Rec). RASL can generate subscription suspension confirmation once the subscription is suspended. RASL can also generates subscription resume confirmation once the subscription is resumed. Such events can be read by the subscription manager, which can in turn make API calls to the SPS and/or the billing service, and can additionally generate and publish new events to the stream.

In accordance with an embodiment, the subscription manager can synchronize customer data with customer data management 1111.

In accordance with an embodiment, the subscription manager tenancy and the subscription manager therein can be deployed within a home region associated with an operator 320. In situations where the operator is associated with more than one region or more than one realm, the subscription manager can engage with communication with various singleton services across realms and regions. The subscription manager tenancy can be provided on a per-realm basis, but it can also be provided on a per-operator bias. The subscription manager can span the operator, whether the operator has one realm, multiple realms, one region or multiple regions. If the subscription manager is per operator, then communication with various singleton services will be across realms, as well as across regions. Pricing and billing are deployed together as an operator singleton. Pricing and billing each have their own data stores.

In accordance with an embodiment, an exemplary flow for FIG. 11 can be illustrated by the following. Upon receiving an order for a new subscription, at (1), the subscription manager can create one subscription per order. At (2), via the API calls to the subscription pricing service, the subscription manager can determine the price for the order. At (3), a billing/charging account can be created or modified for the customer/order based on API calls to the billing service 428. Upon such calls, the order process has concluded and the environment of the subscription can be provisioned. At (4), the subscription manager can publish events to the event stream. At (5), the events are consumed as part of the activation. At (6), the subscription manager receives information back regarding the provisioning being completed. The subscription manager can then inform billing that the provisioning has been completed. It should be noted that (5) and (6) as events do not need to be in a particular order.

In accordance with an embodiment, while some services are tightly-coupled, in some instances an operator may have multiple realms, and the subscriptions and events may span the realm boundary, including disconnected realms; in such environment the events operate to span the air gap between the realms.

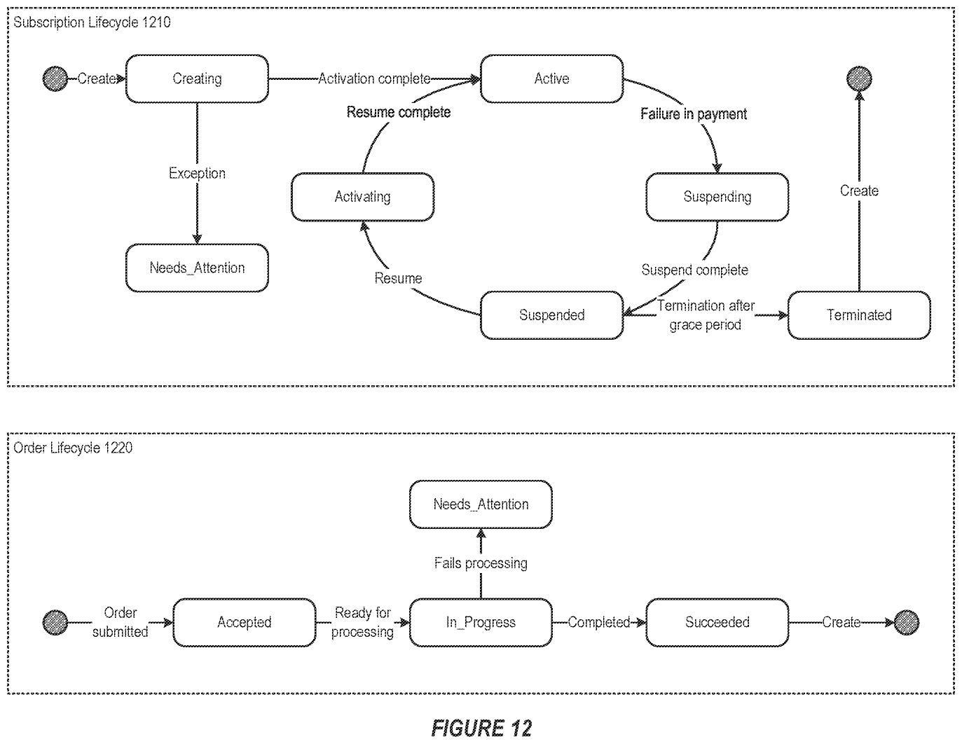

FIG. 12 illustrates exemplary lifecycles for services, in accordance with an embodiment.

In accordance with an embodiment, a subscription lifecycle 1210 is illustrated in FIG. 12. The subscription lifecycle can begin with a subscription create event, which can be followed by a creating event. In the event of an exception being thrown during the creating event, a needs attention event can be thrown.

In accordance with an embodiment, following a successful creating event, the activation of the subscription can begin, and the subscription can be in an active event status. This active event can be maintained for a duration so long as, for example, payment continues to be received. If there is a failure in payment, a suspending event can be initiated, and then the suspend event can be completed. If, after a grace period, the failure event has not been rectified (e.g., a payment has not been received), a terminated event can be entered (which can then lead back to a create event upon a new subscription).

In accordance with an embodiment, if an instruction to resume the suspended subscription is received (e.g., after a payment has been received), an activating event can be entered, and the resumption to active event can again be entered.

In accordance with an embodiment, an order lifecycle 1220 is illustrated in FIG. 12. The order lifecycle can begin with an order being created, which can be followed by a creating event. In the event of an exception being thrown during the creating event, a needs attention event can be thrown.

In accordance with an embodiment, following a successful creating event, the activation of the subscription can begin with an order submission event, and the order can enter an order accepted event. The order, upon it being ready for processing, can enter an in_progress event. Where the order cannot be completed, the order can fail in processing, and can enter a needs_attention event. If, on the other hand, the order can be completed, the order can enter a succeeded event, which can be followed by a create event.

In accordance with an embodiment, as shown in FIG. 12, any changes to a subscription results in generating events. These events can be published to an event stream.

In accordance with an embodiment, each of these above described events can be published to an event stream in a manner the same as or similar to that as described above with regard to the subscription manager publishing events to an event stream.

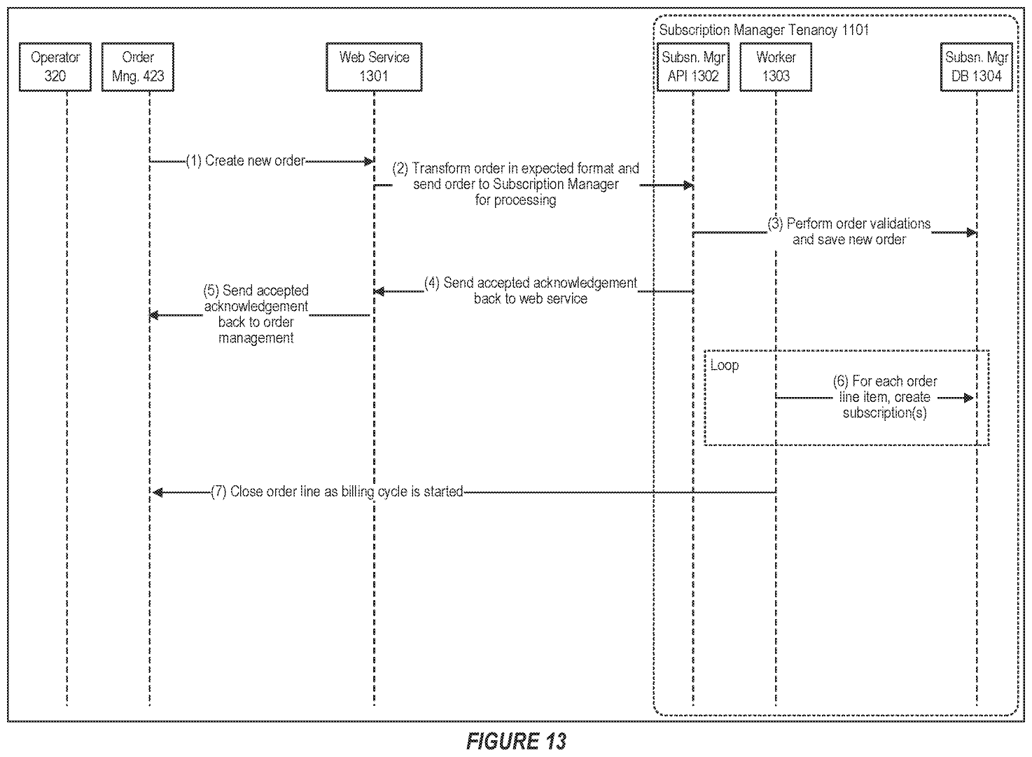

FIG. 13 illustrates a flow chart for an order creation, in accordance with an embodiment.

In accordance with an embodiment, an order manager 423 can, at (1) create a new order for subscription to a web service 1301. At (2), the web service can transform the order into an expected subscription manager format and send the order to the subscription manager for processing. Note that this communication from the web service 1301 into the subscription tenancy 1101 can cross regions and/or realms.

In accordance with an embodiment, the communication can be received via a subscription API 1302, and at (3), a worker within the subscription tenancy can perform order validations and save the new order as an event at the database 1304.

In accordance with an embodiment, at (4), via the API, an acknowledgement of acceptance of the new order can be sent back to the web service, which, in turn, can at (5) send an accepted acknowledgement back to the order manager.

In accordance with an embodiment, the worker within the subscription tenancy can operate, on a loop, for each order line item, to create one or more subscriptions.

In accordance with an embodiment, at (7), the order line can be closed as the billing cycle is initiated.

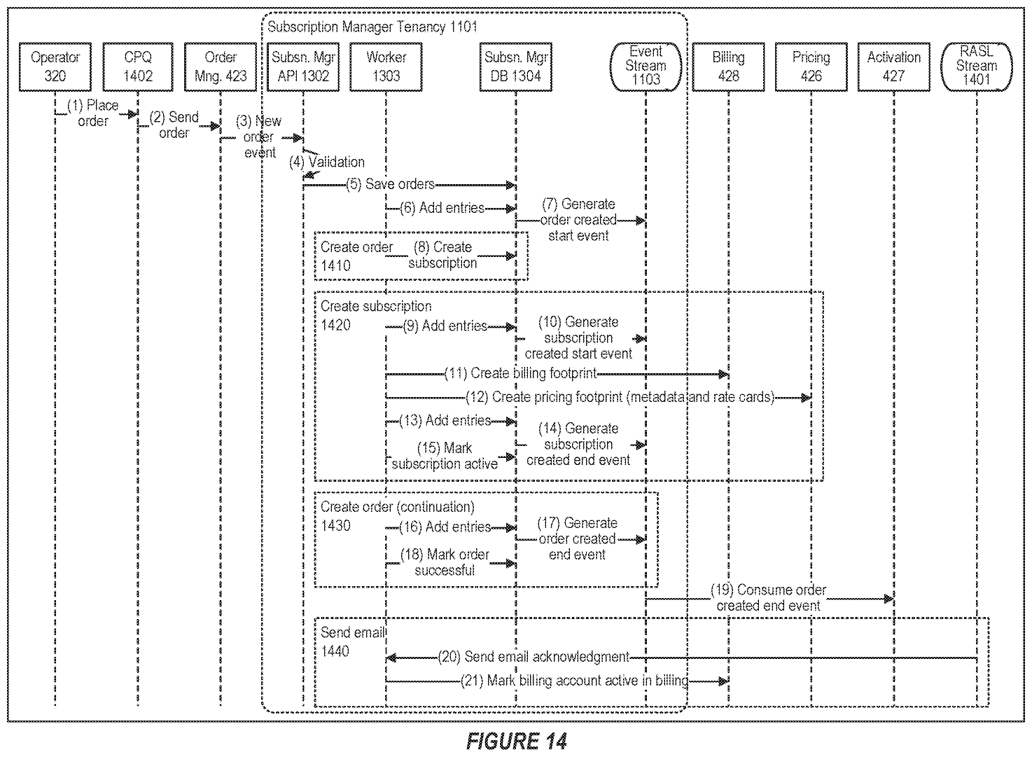

FIG. 14 is a flowchart of an order creation, in accordance with an embodiment.

In accordance with an embodiment, a flowchart for a new order to create a subscription is detailed in FIG. 14. Such an order creation flow can begin with an operator 320 placing an order (1) to a configuration, pricing and quote (CPQ) component 1402. CPQ can then, at (2) send the order to an order manager 423, which can, at (3) communicate a new order event via an API 1302 within the subscription tenancy.

In accordance with an embodiment, the API 1302 can, at (4) perform a validation on the new order, and then, at (5), assuming a successful validation, save the order to the database 1304. Upon the order being saved, at (6), the worker 1303 can add entries to the order at the database.

In accordance with an embodiment, at (7), the subscription manager can publish a generate order created start event to the event stream 1103.

In accordance with an embodiment, a create order loop 1410 can have the worker 1303, at (8), create a subscription to the database 1304.

In accordance with an embodiment a create subscription loop 1420 can begin at (9) with the worker adding entries to the database 1304. The database can, in turn at (10), generate subscription created start events, which can be published to the event steam 1103. At (11), the worker can create a billing footprint and communicate, via an API, with a billing service 428 such footprint. At (12), the worker can create a pricing footprint (e.g., metadata and rate cards), and communicate, via an API, with a pricing service 426 such footprint. At (13), the worker can add entries to the database, which can publish a generate subscription created end event, which is then pushed, at (14) to the event stream 1103. Such a create subscription loop can also indicate, at (15), and mark the subscription as active.

In accordance with an embodiment, the create order (continuation) 1430 (that is, a continuation of the create order event 1410) can begin at (16) with the worker adding entries to the database, which can generate order created end events, which, at (17), are pushed to the event stream 1103. At (18), the worker can mark the order as successful to the database.

In accordance with an embodiment, at (19), downstream services that are not tightly-coupled to the subscription manager, such as an activation service 427 can consume events that have published to the event stream, such as the order created end event.

In accordance with an embodiment, a send email 1440 can start at (20) where an email acknowledgment is sent by the RASL stream 1401 to the worker of the subscription manager. The worker, in turn, at (21) can mark the billing account active in billing service (e.g., via an API communication).

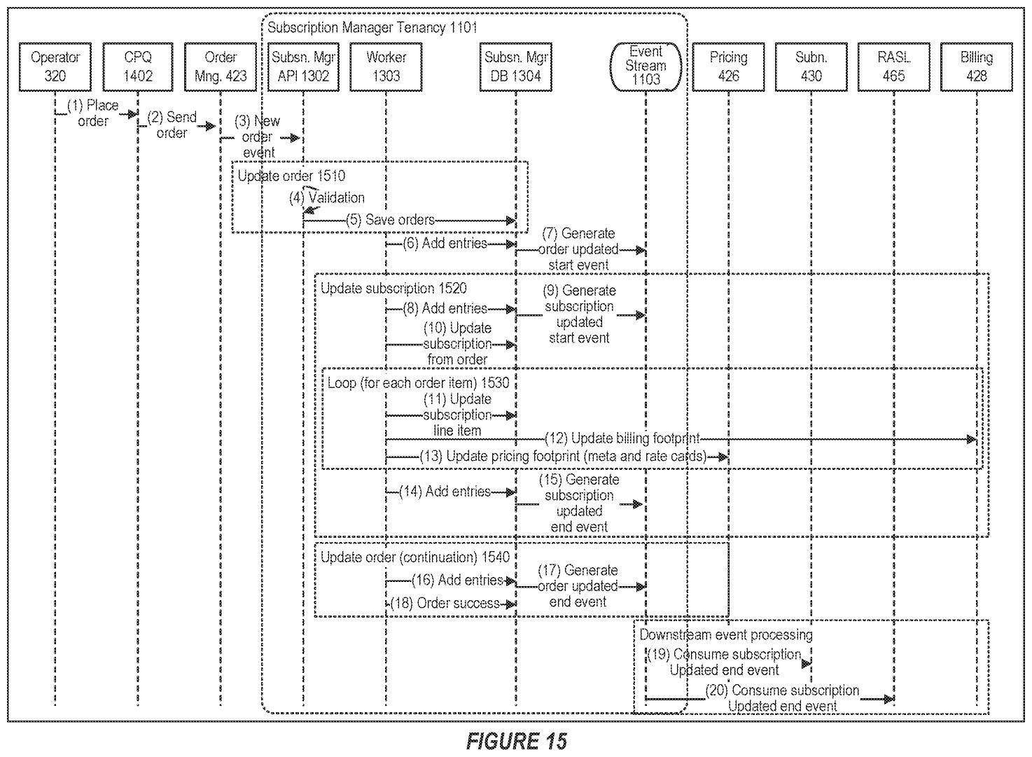

FIG. 15 is a flowchart of an order creation, in accordance with an embodiment.

In accordance with an embodiment, a flowchart for a new order to update a subscription is detailed in FIG. 15. Such an order creation flow can begin with an operator 320 placing an order (1) to a configuration, pricing and quote (CPQ) component 1402. CPQ can then, at (2) send the order to an order manager 423, which can, at (3) communicate a new order event via the API 1302 within the subscription tenancy.

In accordance with an embodiment, in an update order 1510, the API 1302 can, at (4) perform a validation on the new order, and then, at (5), assuming a successful validation, save the order to the database 1304. Upon the order being saved, at (6), the worker 1303 can add entries to the order at the database.

In accordance with an embodiment, at (7), an order updated start event can be generated and pushed to the event stream 1103 (e.g., a stream of events stored at a database or datastore).

In accordance with an embodiment, in an update subscription cycle 1520, the worker can, at (8), add entries to the database 1304, which can then, at (9) generate a subscription updated start event, which can be pushed to the event stream 1103.

In accordance with an embodiment, a loop 1530 can be run for each order item, where, at (11), the worker 1303 can update the subscription line item, and then update the billing footprint (12) via an API call to the billing service 428. The worker can additionally update the pricing footprint (metadata and rate cards) at (13) via API calls to the pricing service 426.

In accordance with an embodiment, the worker can add entries to the database at (14), which can generate a subscription updated end event and push that, at (15) to the event stream 1103.

In accordance with an embodiment the update order (continuation) 1540 (that is, a continuation of the update order event 1510) can begin at (16) with the worker adding entries to the database, which can generate and order updated end event, which, at (17), is pushed to the event stream 1103. At (18), the worker can mark the order as successful to the database.

In accordance with an embodiment, at (19), downstream services that are not tightly-coupled to the subscription manager, such as the subscription service 430 and the RASL service (at (20)) can consume events that have been pushed to the event stream, such as the updated end event.

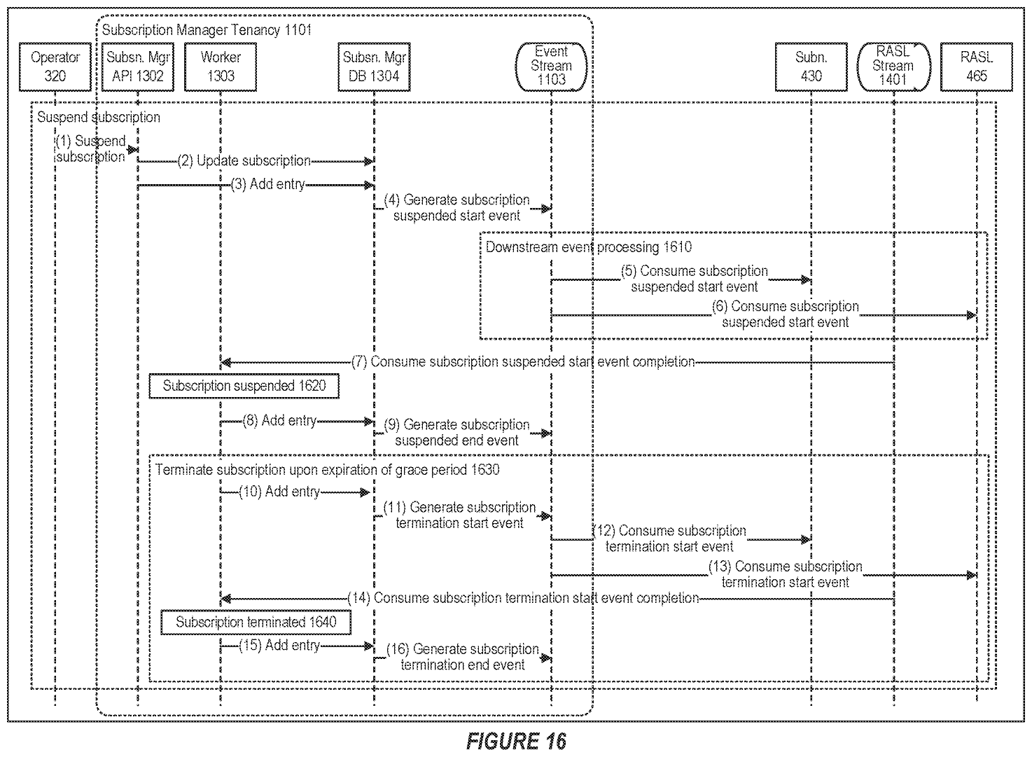

FIG. 16 is a flowchart of an order creation, in accordance with an embodiment.

In accordance with an embodiment, a flowchart to suspend or terminate a subscription is detailed in FIG. 16. Such an order creation flow can begin with an operator 320 giving instructions to the API at (1) to a suspend or terminate an active subscription. The API can, at (2), update the subscription at the database 1304 and add an entry indicating the update to the subscription. The database, at (4) can generate and push to the event stream a generate subscription suspend start event.

In accordance with an embodiment, those services that are loosely-coupled with the subscription manager, such as the subscription service 430, the RASL 465 and its associated stream 1401, can, at downstream processing 1610, consume this generated event from the event stream at (5) and (6).

In accordance with an embodiment, in turn, the worker 1303 can consume from the RASL stream a subscription suspended start event completion, at which point the subscription is suspended.

In accordance with an embodiment, such a suspension of a service can terminate after a grace period, at which the service can be terminated 1630, where, at (8), the worker can add an entry to the database, which, at (9), can generate and push to the event stream 1103 a generate subscription termination start event. Again, the downstream services that are loosely-coupled can consume this event at (12) and (13).

In accordance with an embodiment, at (14), the subscription manager, via its worker, can consume subscription termination start event completion, at which point the service can be terminated 1640. The worker can then, at (15) add an entry to the database, which can generate and publish to the event stream a subscription termination end event.

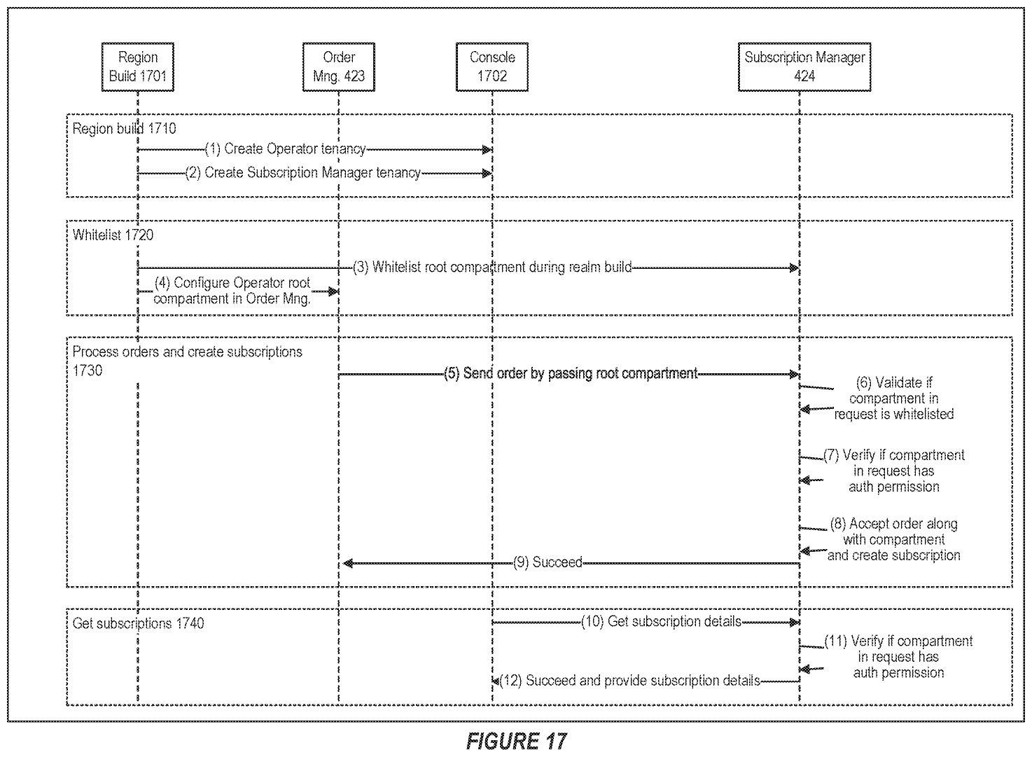

FIG. 17 illustrates a flowchart for an authorization model, in accordance with an embodiment.

In accordance with an embodiment, the authorization model depicted in FIG. 17 generally comprises four components: region build 1710, whitelist 1720, process orders and create subscriptions 1730, and get subscriptions 1740.

In accordance with an embodiment, the region build component 1710 can begin with region build creating an operator tenancy (1) in communication with the console 1702. After an operator tenancy has been created, a subscription manager tenancy can be created at (2), which can be associated with/deployed in conjunction with the operator tenancy.

In accordance with an embodiment, in the whitelist component 1720, the region build component can, at (3), whitelist a root compartment during the realm build and communicate this to the subscription manager 424. As well, at (4), an operator root compartment can be configured in the order manager 423.

In accordance with an embodiment, in the process orders and create subscriptions component 1730, the order manager can, at (5), send orders by passing a root compartment to the subscription manager 424. At (6), the subscription manager can validate that whether the compartment in the request is whitelisted. If so, at (7), the subscription manager can verify if the compartment in the request has authorization permission. If so, at (8), the subscription manager can accept the order along with compartment and create the subscription. At (9), the subscription manager can pass a success message back to the order manager.

In accordance with an embodiment, in the get subscription component 1740, the console can, at (10) request/send a get instruction for the subscription details from the subscription manager. The subscription manager can, at (11), verify if the compartment in request as authorization and permission. If so, at (12), the subscription manager can provide the subscription details back to the console.

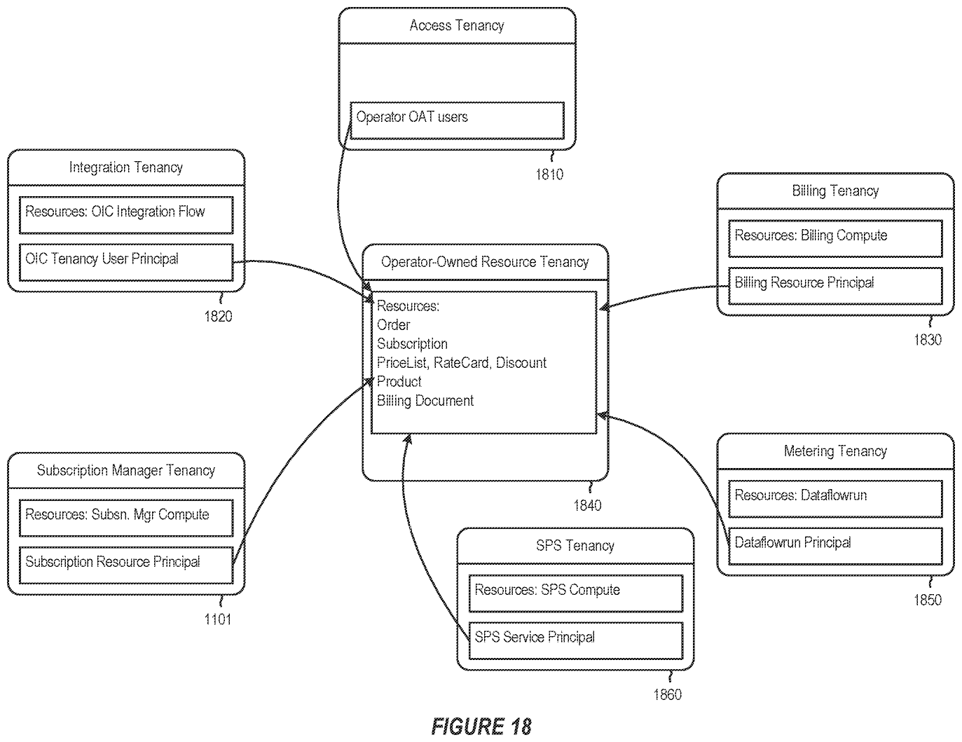

FIG. 18 illustrates various tenancies, in accordance with an embodiment.

In accordance with an embodiment, in the above described systems and methods, much of the data is owned by the operator and not the cloud infrastructure provider. However, data owned by the operator may be useful to or needed by the cloud infrastructure provider. The operator-owned resource tenancy 1840 is provided as a mechanism to provide access to operator data while still maintaining security over such data.

In accordance with an embodiment, the access tenancy (operator access tenancy) 1810 can comprise a tenancy that belongs to an operator within a realm. Data belonging to the operator and used in and/or generated within the access tenancy can be stored at or tied to an operator-owned resource tenancy 1840, such as resource data, order data, subscription data, pricelist, rate card, and discount data, product data, and billing documents.

In accordance with an embodiment, however, other tenancies and services therein may have need to access this data. Such tenancies, such as the integration tenancy 1820, the billing tenancy 1830, the subscription tenancy 1101, the metering tenancy 1850, and the SPS tenancy 1860, as well as the services therein, can access the operator-owned data by accessing the intermediate resource tenancy instead of accessing the tenancy directly. This can ensure that that these services are not the owners of the data—the data is tied to a resource tenancy which is owned by the operator. All the users access the resources (order, subscription, price list, rate card, discount, product, billing document) via this operator-owned resource tenancy.

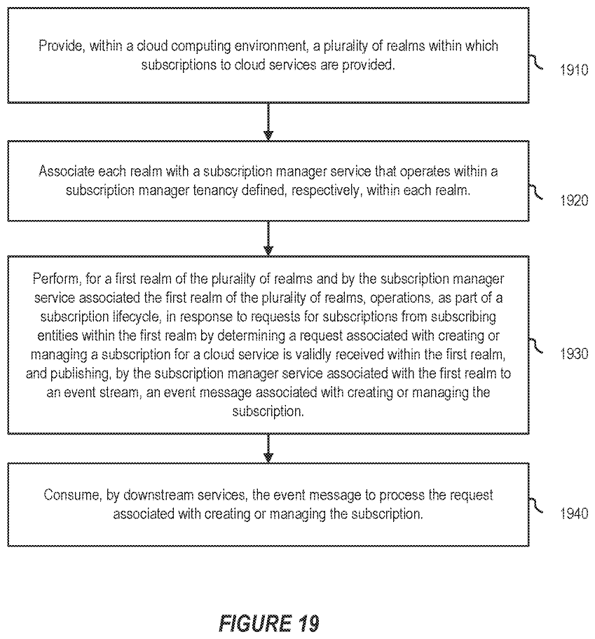

FIG. 19 is a flowchart of a method, in accordance with an embodiment.

In accordance with an embodiment, at step 1910, the method can provide, within a cloud computing environment, a plurality of realms within which subscriptions to cloud services are provided.

In accordance with an embodiment, at step 1920, the method can associate each realm with a subscription manager service that operates within a subscription manager tenancy defined, respectively, within each realm.

In accordance with an embodiment, at step 1930, the method can perform, for a first realm of the plurality of realms and by the subscription manager service associated the first realm of the plurality of realms, operations, as part of a subscription lifecycle, in response to requests for subscriptions from subscribing entities within the first realm by determining a request associated with creating or managing a subscription for a cloud service is validly received within the first realm, and publishing, by the subscription manager service associated with the first realm to an event stream, an event message associated with creating or managing the subscription.

In accordance with an embodiment, at step 1940, the method can consume, by downstream services, the event message to process the request associated with creating or managing the subscription.

In accordance with an embodiment, the method can be performed on one or more computers comprising one or more processors, wherein the cloud computing environment operates on the one or more computers.

In accordance with an embodiment, the subscription manager service operating within a subscription manager tenancy of the first realm can operate independently of a subscription manager service operating within a subscription manager tenancy of a second realm associated with a second entity. The first entity can comprise a first operator that provides subscriptions to customers within realms associated with the first operator, and the second entity can comprise a second operator that provides subscriptions to customers within realms associated with the second operator.

In accordance with an embodiment, determining the request associated with the subscription is validly received within the realm can comprise determining a compartment associated with the request is authorized to communicate the request to the subscription manager service for processing.

In accordance with an embodiment, the event message associated with the subscription can be generated, by the subscription manager service, prior to being published to the event stream.

In accordance with an embodiment, in response to the event message being consumed by downstream services in order to process the request associated with creating or managing the subscription, one or more responses can be generated by the downstream services.

In accordance with an embodiment, in response to the downstream services generating one or more responses, the subscription manager service can generate another event message associated with the subscription. The another event message can be published, by the subscription manager service, to the event stream.

In accordance with an embodiment, an operator tenancy can be defined within the first realm, the operator tenancy being associated with the first entity. As well, an intermediate resource tenancy can be defined within the first realm, the intermediate resource tenancy being associated with the first entity. A subscription manager tenancy can be associated with a provider of the cloud computing environment.

In accordance with an embodiment, the subscription manager service can access resources owned by the first entity via the intermediate resource tenancy.

The examples of various systems illustrated above are provided for purposes of illustrating a computing environment which can be used to provide dedicated or private label cloud environments, for use by tenants of a cloud infrastructure in accessing subscription-based software products, services, or other offerings associated with the cloud infrastructure environment. In accordance with other embodiments, the various components, processes, and features described herein can be used with other types of cloud computing environments.

In accordance with various embodiments, the teachings herein can be implemented using one or more computer, computing device, machine, or microprocessor, including one or more processors, memory and/or computer readable storage media programmed according to the teachings herein. Appropriate software coding can readily be prepared by skilled programmers based on the teachings of the present disclosure, as will be apparent to those skilled in the software art.

In some embodiments, the teachings herein can include a computer program product which is a non-transitory computer readable storage medium (media) having instructions stored thereon/in which can be used to program a computer to perform any of the processes of the present teachings. Examples of such storage mediums can include, but are not limited to, hard disk drives, hard disks, hard drives, fixed disks, ROMs, RAMs, EPROMs, EEPROMs, DRAMs, VRAMs, flash memory devices, or other types of storage media or devices suitable for non-transitory storage of instructions and/or data.

The foregoing description has been provided for the purposes of illustration and description. It is not intended to be exhaustive or to limit the scope of protection to the precise forms disclosed. Further modifications and variations will be apparent to the practitioner skilled in the art.

The embodiments were chosen and described in order to best explain the principles of the teachings herein and their practical application, thereby enabling others skilled in the art to understand the various embodiments and with various modifications that are suited to the particular use contemplated. It is intended that the scope be defined by the following claims and their equivalents.

What is claimed is:

1. A system, comprising:
one or more computers comprising one or more processors and a cloud computing environment operating thereon, said cloud computing environment comprising a plurality of realms within which subscriptions to cloud services are provided;
wherein each realm is associated with a subscription manager service that operates within a subscription manager tenancy defined, respectively, within each realm;
wherein for a first realm of the plurality of realms, the first realm being associated with a first entity, the subscription manager service associated with the first realm performs operations, as part of a subscription lifecycle, in response to requests for subscriptions from subscribing entities within the first realm by:
determining a request associated with creating or managing a subscription for a cloud service is validly received within the first realm, and
publishing, by the subscription manager service associated with the first realm to an event stream, an event message associated with creating or managing the subscription;
wherein the event message is consumed by downstream services to process the request associated with creating or managing the subscription.

2. The system of claim 1,
wherein the subscription manager service operating within a subscription manager tenancy of the first realm operates independently of a subscription manager service operating within a subscription manager tenancy of a second realm associated with a second entity;
wherein the first entity is a first operator that provides subscriptions to customers within realms associated with the first operator;
wherein the second entity is a second operator that provides subscriptions to customers within realms associated with the second operator.

3. The system of claim 1,
wherein determining the request associated with the subscription is validly received within the realm comprises:
determining a compartment associated with the request is authorized to communicate the request to the subscription manager service for processing.

4. The system of claim 1,
wherein the event message associated with the subscription is generated, by the subscription manager service, prior to being published to the event stream.

5. The system of claim 1,
wherein in response to the event message being consumed by downstream services in order to process the request associated with creating or managing the subscription, one or more responses are generated by the downstream services.

6. The system of claim 5,
wherein in response to the downstream services generating one or more responses, the subscription manager service generates another event message associated with the subscription; and
wherein the other event message is published, by the subscription manager service, to the event stream.

7. The system of claim 1,
wherein an operator tenancy is defined within the first realm, the operator tenancy being associated with the first entity;
wherein an intermediate resource tenancy is defined within the first realm, the intermediate resource tenancy being associated with the first entity; and
wherein the subscription manager tenancy is associated with a provider of the cloud computing environment.

8. The system of claim 7,
wherein the subscription manager service accesses resources owned by the first entity via the intermediate resource tenancy.

9. A method, comprising:
providing, within a cloud computing environment, a plurality of realms within which subscriptions to cloud services are provided;
associating each realm with a subscription manager service that operates within a subscription manager tenancy defined, respectively, within each realm;
performing, for a first realm of the plurality of realms and by the subscription manager service associated the first realm of the plurality of realms, operations, as part of a subscription lifecycle, in response to requests for subscriptions from subscribing entities within the first realm by:
determining a request associated with creating or managing a subscription for a cloud service is validly received within the first realm, and
publishing, by the subscription manager service associated with the first realm to an event stream, an event message associated with creating or managing the subscription; and
consuming the event message by downstream services to process the request associated with creating or managing the subscription;
wherein the method is performed on one or more computers comprising one or more processors, wherein the cloud computing environment operates on the one or more computers.

10. The method of claim 9,
wherein the subscription manager service operating within a subscription manager tenancy of the first realm operates independently of a subscription manager service operating within a subscription manager tenancy of a second realm associated with a second entity;
wherein the first entity is a first operator that provides subscriptions to customers within realms associated with the first operator;
wherein the second entity is a second operator that provides subscriptions to customers within realms associated with the second operator.

11. The method of claim 9,
wherein determining the request associated with the subscription is validly received within the realm comprises:
determining a compartment associated with the request is authorized to communicate the request to the subscription manager service for processing.

12. The method of claim 9,
wherein the event message associated with the subscription is generated, by the subscription manager service, prior to being published to the event stream.

13. The method of claim 9,
wherein in response to the event message being consumed by downstream services in order to process the request associated with creating or managing the subscription, one or more responses are generated by the downstream services.

14. The method of claim 13,
wherein in response to the downstream services generating one or more responses, the subscription manager service generates another event message associated with the subscription; and
wherein the other event message is published, by the subscription manager service, to the event stream.

15. The method of claim 9,
wherein an operator tenancy is defined within the first realm, the operator tenancy being associated with the first entity;
wherein an intermediate resource tenancy is defined within the first realm, the intermediate resource tenancy being associated with the first entity; and
wherein the subscription manager tenancy is associated with a provider of the cloud computing environment.

16. The method of claim 15,
wherein the subscription manager service accesses resources owned by the first entity via the intermediate resource tenancy.

17. A non-transitory computer readable storage medium having instructions thereon, which when read and executed cause a computer to perform steps comprising:
providing, within a cloud computing environment, a plurality of realms within which subscriptions to cloud services are provided;
associating each realm with a subscription manager service that operates within a subscription manager tenancy defined, respectively, within each realm;
performing, for a first realm of the plurality of realms and by the subscription manager service associated the first realm of the plurality of realms, operations, as part of a subscription lifecycle, in response to requests for subscriptions from subscribing entities within the first realm by:
determining a request associated with creating or managing a subscription for a cloud service is validly received within the first realm, and
publishing, by the subscription manager service associated with the first realm to an event stream, an event message associated with creating or managing the subscription; and
consuming the event message by downstream services to process the request associated with creating or managing the subscription.

18. The non-transitory computer readable storage medium of claim 17,
wherein the subscription manager service operating within a subscription manager tenancy of the first realm operates independently of a subscription manager service operating within a subscription manager tenancy of a second realm associated with a second entity;
wherein the first entity is a first operator that provides subscriptions to customers within realms associated with the first operator;
wherein the second entity is a second operator that provides subscriptions to customers within realms associated with the second operator.

19. The non-transitory computer readable storage medium of claim 17,
wherein determining the request associated with the subscription is validly received within the realm comprises:
determining a compartment associated with the request is authorized to communicate the request to the subscription manager service for processing.

20. The non-transitory computer readable storage medium of claim 17,
wherein the event message associated with the subscription is generated, by the subscription manager service, prior to being published to the event stream.

21. The non-transitory computer readable storage medium of claim 17,
wherein in response to the event message being consumed by downstream services in order to process the request associated with creating or managing the subscription, one or more responses are generated by the downstream services.

22. The non-transitory computer readable storage medium of claim 21,
wherein in response to the downstream services generating one or more responses, the subscription manager service generates another event message associated with the subscription; and
wherein the other event message is published, by the subscription manager service, to the event stream.

23. The non-transitory computer readable storage medium of claim 17,
wherein an operator tenancy is defined within the first realm, the operator tenancy being associated with the first entity;
wherein an intermediate resource tenancy is defined within the first realm, the intermediate resource tenancy being associated with the first entity; and
wherein the subscription manager tenancy is associated with a provider of the cloud computing environment.

24. The non-transitory computer readable storage medium of claim 23,
wherein the subscription manager service accesses resources owned by the first entity via the intermediate resource tenancy.
